(19) United States
(12) Patent Application Publication
(10) Pub. No.: US 2013/0290449 A1
(43) Pub. Date: Oct. 31, 2013

(54) PRIVACY-BASED SOCIAL CONTENT BROADCAST SYSTEMS AND METHODS

(71) Applicant: ORIGAMI LABS, INC., Mountain View, CA (US)

(72) Inventors: Vibhu Norby, Mountain View, CA (US); Oliver Cameron, Elland (GB)

(73) Assignee: Origami Labs, Inc., Mountain View, CA (US)

(21) Appl. No.: 13/865,936

(22) Filed: Apr. 18, 2013

Related U.S. Application Data
(60) Provisional application No. 61/806,191, filed on Mar. 28, 2013.
(60) Provisional application No. 61/638,440, filed on Apr. 25, 2012.

(51) Int. Cl. H04L 12/58

(52) U.S. Cl. CPC H04L 51/32
USPC 709/206

(57) ABSTRACT

A technique and system for delivering content to users and subscribers in a privacy based network. The technique can include creating a circle between the user and any number of subscribers by a privacy based social content broadcasting server system. Content can be received from the user and sent to the any number of subscribers through the circle. Content can also be received from one of the any number of subscribers and sent to the user and the other subscribers through the circle.

This application claims priority to U.S. Provisional Patent Application No. 61/638,440, entitled PRIVACY-BASED SOCIAL CONTENT BROADCAST SYSTEMS AND METHODS, filed Apr. 25, 2012; and U.S. Provisional Patent Application No. 61/806,191, entitled PRIVACY-BASED SOCIAL CONTENT BROADCAST SYSTEMS AND METHODS, filed Mar. 28, 2013, both of which are incorporated herein by reference.

### BACKGROUND

People have used a variety of media to connect to one another. For instance, people have used land-based telephones and mobile phones to exchange voice and sound communications. Email programs have facilitated the exchange of data, such as textual materials, computer files, and media. Social media programs have facilitated human connections and have allowed individuals and businesses to leverage the benefits of the virtual and real-life relationships that people have with one another.

However, existing connection media are not without their respective deficiencies. Telephones are made for transmitting voice and sound. Land-based telephones do not easily accommodate transmission of data and video. Similarly, mobile phones are made to transmit data and voice and rudimentary messages in the form of Short Messaging Service (SMS) messages. Though many mobile phones are equipped with data services, the transmission of textual or video content requires additional applications that are beyond the facilities of basic cellular phone services. Further, email services require people to be directly connected to one another for each communication and do not easily facilitate the pushing of content to multiple people on a user list. Email broadcasts are cumbersome and often inefficient for users. Though many social media programs facilitate a broadcast in the form of, for example, a news feed, social media programs do not allow users to easily control the other users that see broadcasted materials. Social media programs therefore have privacy issues.

These and other problems reside in the art.

### SUMMARY

The following embodiments and aspects thereof are described and illustrated in conjunction with systems, tools, and methods that are meant to be exemplary and illustrative, not necessarily limiting in scope. In various embodiments, one or more of the above-described problems have been addressed, while other embodiments are directed to other improvements.

A technique and systems for delivering content to users and subscribers in a privacy based network. The technique can include authenticating a user. A circle can be created between the user and any number of subscribers by a privacy based social content broadcasting server system. The circle can be a private newsfeed for the user and the any number of subscribers. The technique can include receiving content from the user and sending it to the any number of subscribers through the circle. The content can be sent to the any number of subscribers as a short message service message. The user and the subscribers can be associated through some other relationship other than merely being in the same circle together. For example, the user and the subscribers can be friends in another network.

The technique can also include receiving content from at least one of the any number of subscribers and sending the content through the circle to the user and the other subscribers of the any number of subscribers. The content that is received from the any number of subscribers can be a response to the content from the user that is sent to the any number of subscribers through the circle.

The technique can also include creating the circle based on information about the subscriber. The information about the subscriber can be received from the user or retrieved from a network of which the user and the subscriber are both associated.

These and other advantages will become apparent to those skilled in the relevant art upon a reading of the following descriptions and a study of the several examples of the drawings.

### BRIEF DESCRIPTION OF THE DRAWINGS

FIG. 1 shows a diagram of an example of a network environment.

FIG. 2A shows a flowchart of an example of a privacy-based social content broadcast method.

FIG. 2B shows a flowchart of a privacy-based social content broadcast method.

FIG. 3 shows a diagram of an example of a computer

FIG. 4 shows an example of a login screen.

FIG. 5 shows an example of a user introduction screen.

FIG. 6 shows an example of a screen depicting a user feedback circle.

FIG. 7 shows an example of a screen depicting a user feedback circle.

FIG. 8 shows an example of a screen depicting a user feedback circle.

FIG. 9 shows an example of a screen depicting a user feedback circle.

FIG. 10 shows an example of a screen depicting a story shared by a circle.

FIG. 11 shows an example of a screen depicting a family circle.

FIG. 12 shows an example of a screen depicting user settings.

FIG. 13 shows an example of a screen depicting user content of users in a user circle.

FIG. 14 shows an example of a screen depicting a subscriber list associated with a personal circle.

FIG. 15 shows an example of a screen depicting a post to a user feedback circle.

FIG. 16 shows an example of a screen depicting personal contact verification settings.

FIG. 17 shows an example of a screen depicting a Short Messaging Service (SMS) authorization.

FIG. 18 shows an example of a screen depicting an email authorization.

FIG. 19 shows an example of a screen depicting a home screen of a privacy-based social content broadcast service provider.

FIG. 20 shows an example of a screen depicting a home screen of a privacy-based social content service provider.

FIG. 21 shows an example of a screen depicting notification settings.

FIG. 22 shows an example of a screen depicting settings for a user feedback circle.

FIG. 23 shows an example of a screen depicting settings for a user feedback circle.

FIG. 24 shows an example of a screen depicting settings to create a personal circle.

FIG. 25 shows an example of a screen depicting settings to add a subscriber to a personal circle.

FIG. 26 shows an example of a screen depicting settings to add contact information of a subscriber to a personal circle.

FIG. 27 shows an example of a screen depicting a list of circles of which a user is a member.

FIG. 28 shows an example of a screen depicting a home screen of a personal circle.

FIG. 29 shows an example of a screen depicting a subscriber list associated with a personal circle.

FIG. 30 shows an example of a screen depicting story creation associated with a personal circle.

FIG. 31 shows an example of a screen depicting a home screen of a personal circle.

FIG. 32 shows an example of a screen depicting story creation associated with a personal circle.

FIG. 33 shows an example of a screen depicting story creation associated with a personal circle.

FIG. 34 shows an example of a screen depicting a request to turn on magic stories.

FIG. 35 shows an example of a screen depicting story publication associated with a personal circle.

FIG. 36 shows an example of a screen depicting a list of circles of which a user is a member.

FIG. 37 shows an example of a screen depicting a home screen of a personal circle.

FIG. 38 shows an example of a screen depicting depicting story creation associated with a personal circle.

FIG. 39 shows an example of a screen depicting a subscriber list associated with a personal circle.

FIG. 40 shows an example of a screen of a mobile phone application.

FIG. 41 shows an example of a screen of a mobile phone application.

### DETAILED DESCRIPTION

Described are techniques that those of skill in the art can implement in numerous ways. For instance, those of skill in the art can implement the techniques described herein using a process, an apparatus, a system, a composition of matter, a computer program product embodied on a computer readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used herein, the term ‘processor’ refers to one or more devices, circuits, and/or processing cores configured to process data, such as computer program instructions.

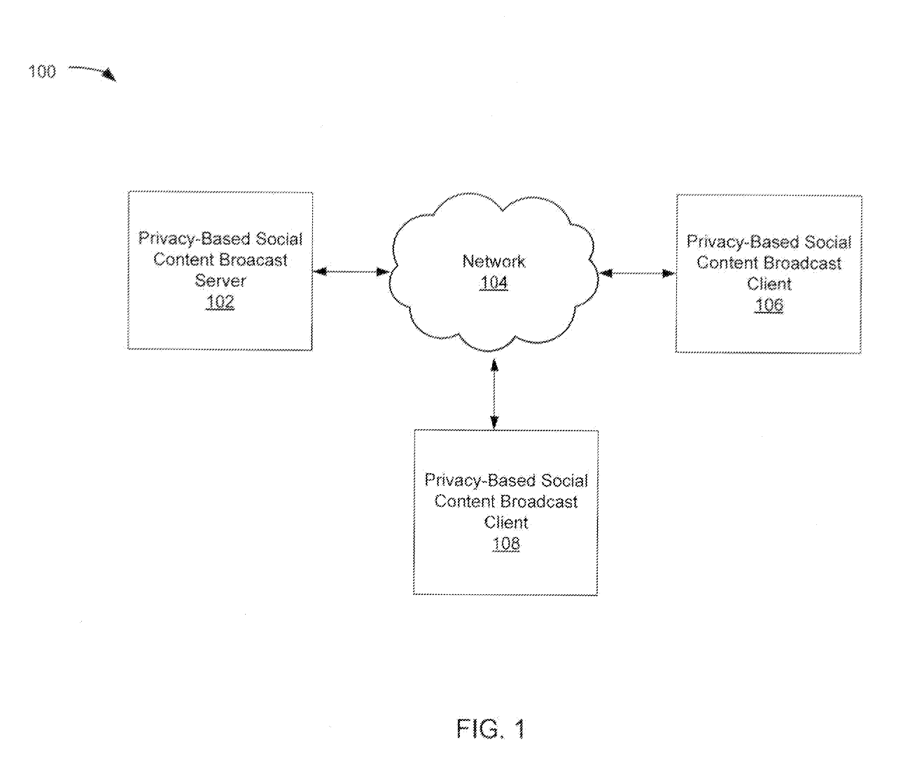

FIG. 1 shows a diagram of an example of a network environment 100. In the example of FIG. 1, the network environment 100 can include a privacy-based social content broadcast server 102, a network 104, a privacy-based social content broadcast client 106, and a privacy-based social content broadcast client 108. In the example of FIG. 1, the network 104 connects to each of the privacy-based social content broadcast server 102, the privacy-based social content broadcast client 106, and the privacy-based social content broadcast client 108.

In the example of FIG. 1, the privacy-based social content broadcast server 102 can include one or more engines. As used herein, an “engine” includes a dedicated or shared processor and, typically, firmware or software modules that are executed by the processor. Depending upon implementation-specific or other considerations, an engine can be centralized or its functionality distributed. An engine includes special purpose hardware, firmware, or software embodied in a computer-readable medium for execution by the processor. As used herein, a computer-readable medium is intended to include all mediums that are statutory (e.g., in the United States, under 35 U.S.C. §101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 1, the privacy-based social content broadcast can include an operating system. An operating system is a set of programs that manage computer hardware resources, and provides common services for application software. The operating system enables an application to run on a computer, whereas only applications that are self-booting can generally run on a computer that does not have an operating system. Operating systems are found in almost any device that includes a computer (e.g., cellular phones, video game consoles, web servers, etc.). Examples of popular modern operating systems are Linux, Android, iOS, Mac OS X, and Microsoft Windows®. Embedded operating systems are designed to operate on small machines like PDAs with less autonomy (Windows CE and Minix 3 are some examples of embedded operating systems). Operating systems can be distributed, which makes a group of independent computers act in some respects like a single computer. Operating systems often include a kernel, which controls low-level processes that most users cannot see (e.g., how memory is read and written, the order in which processes are executed, how information is received and sent by I/O devices, and devices how to interpret information received from networks). Operating systems often include a user interface that interacts with a user directly to enable control and use of programs. The user interface can be graphical with icons and a desktop or textual with a command line. Application programming interfaces (APIs) provide services and code libraries. Which features are considered part of the operating system is defined differently in various operating systems, but all of the components are treated as part of the operating system herein for illustrative convenience.

In the example of FIG. 1, the privacy-based social content broadcast server 102 can include one or more datastores that hold content, editing layers, and/or other data. A datastore can be implemented, for example, as software embodied in a physical computer-readable medium on a general- or specific-purpose machine, in firmware, in hardware, in a combination thereof, or in an applicable known or convenient device or system. Datastores herein are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described herein.

Datastores can include data structures. As used herein, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

In the example of FIG. 1, the privacy based social content broadcast server 102 can implement features of a privacy based social content broadcast service provider. In various embodiments, the privacy based social content broadcast service provider can allow users to create groups of contacts from an Address Book and then send messages to the groups of contacts through a proprietary application. The members of the contact groups can then respond to the users' messages via media such as text messages, email, or through the proprietary application.

In some embodiments, the privacy based social content broadcast service provider can provide social content broadcasting while enforcing a high degree of privacy. More specifically, the service provider can prevent a user from transmitting any messages unless the user writes a message, decides to share the message, and decides to send the message. Comments on a story are not sent until a person has already responded to a story. The privacy based social content broadcast service provider can facilitate the creation of “circles.” As used herein, a circle is a private news feed for a user and a group of the user's friends. A circle can comprise a specific set of subscribers that a user has manually entered in and categorized. A circle can also comprise a subset of contacts taken from an email client, a phonebook, or a social media account. In various embodiments, a circle can comprise a set of subscribers having a specific or general association (e.g., friendship, alumni status, common experiences, or familial connections) with the user. The subscribers can receive news feeds from the user. The news feeds can include text, images, sounds, or video. The news feeds are private in that the contents of the news feeds are not broadcasted to people other than the user and his or her subscribers. Thus, the link provides a user with a high level of control over the specific subscribers that can receive his or her news feeds. When a user creates a circle in the application from the user's contacts, the privacy based social content broadcast service provider need not send any message or invitation to the people in the circle. In various embodiments, even though a user sees a message in a circle that the user created a circle, the fact of the circle is not sent to circle subscribers and the circle is only visible to the subscribers who download the proprietary application and join the circle. Thus, new magic stories, new cover photos, and invitations to join circles are not sent. The privacy based social content broadcast service provider consequently creates an incentive for a user to get others to join the privacy based social content broadcast service provider and create accounts.

In various embodiments, people can join the circle of a user having an account with the privacy based social content broadcast service provider. In order for someone to go from being contacted by a text message or email in a circle to being contacted via push notification, the person needs to sign up for an account with the privacy based social content broadcast service, and the privacy based social content broadcast service provider will verify the account information (including, perhaps, the contact information). This can be done by verifying the specific mobile phone number or the specific email address that was provided for the friend by the user.

In some embodiments, the privacy based social content broadcast service provider can facilitate creation of customized or “magic” circles. When a user signs in with social networks (e.g., Facebook®, LinkedIn®, Twitter®, or other social networks), the privacy based social content broadcast service provider can attempt to create logical groups to show the user what kind of circles the user may wish to create. With the user's permission, the privacy based social content broadcast service provider can match the address book contacts with the social network friends, and place them into groups based on the user's profile information. For example, the privacy based social content broadcast service provider can create a group for a user's family, a user's co-workers, and for the user's school if the user has enough people in the address book that share the same profile information. These circles can be called customized or “magic” circles and can be associated with a special set of rules to protect user privacy. For instance, before anyone else is allowed to see a magic circle, the privacy based social content broadcast service provider can ensure the user is able to review the people in the magic circle and remove and add to the user's content.

In various embodiments, the privacy based social content broadcast service provider can support creation of customized or “magic” stories. The first time a user posts into a circle, the user is given the option of turning on the magic stories. The user can also turn it on from the user's circle settings. If the feature is turned on, the privacy based social content broadcast service provider can scan the user's social networks for interesting things every once in a while. Interesting things include popular tweets that the user has made (assuming the tweets are public), the user's birthday, when the user is in a new relationship, when the user changes jobs, when the user gets promoted, when the user changes location, and many other things. The privacy based social content broadcast service provider can facilitate comments on the magic stories by friends of the user just like any other story.

In various embodiments, when a user joins or creates a circle, the user may see a little bio under the user's message. The bio can be generated from the user's social profiles. The privacy based social content broadcast service provider can take a job that the user has set to be currently working at, or the school that the user is at, and try to give other people in the circle a little information about the user's current situation. If the user changes his or her job or your school, the user's magic bio updates by itself. In various embodiments, the user will be allowed to change what the bio says; while in some embodiments, the bio is updated only automatically by the privacy based social content broadcast service provider.

In some embodiments, the privacy based social content broadcast service provider can facilitate integration with social networks. This integration possesses advantages such as: (1) providing an avatar from social networks, (2) making magic circles, (3) creating a magic bio, and (4) creating magic stories.

In various embodiments, the privacy based social content broadcast service provider can implement strict privacy controls. The privacy based social content broadcast service provider need not store a user's contact data. The privacy based social content broadcast service provider need not even store anything outside the phone number and email that the privacy based social content broadcast service provider picked for the people in a user's magic circles. The privacy based social content broadcast service provider can prioritize using email instead of text messages to ensure a better experience. In various embodiments, the privacy based social content broadcast service provider can allow a user to see someone's contact information in a circle that the user actually added.

In the example of FIG. 1, the network 104 can include a computer network. The network 104 can include communication channels to connect server resources and information in the privacy-based social content broadcast server 102 with client resources and information in the privacy-based social content broadcast 106 and 108. In the example of FIG. 1, the network 104 can be implemented as a personal area network (PAN), a local area network (LAN), a home network, a storage area network (SAN), a metropolitan area network (MAN), an enterprise network such as an enterprise private network, a virtual network such as a virtual private network (VPN), or other network. One network of particular interest for an online application service is the World Wide Web (“the Web”), which is one of the services running on the Internet. The Web is a system of interlinked hypertext documents accessed via the Internet. With a web browser, one can view web pages that can contain text, images, videos, and other multimedia and navigate between the web pages via hyperlinks. The network 104 can serve to connect people located around a common area, such as a school, workplace, or neighborhood. The network 104 can also connect people belonging to a common organization, such as a workplace. Portions of the network 104 can be secure and other portions of the network 104 need not be secure.

In the example of FIG. 1, the network 104 can use a variety of physical or other media to connect the privacy-based social content broadcast server 102 with the privacy-based social content broadcast clients 106 and 108. For instance, the network 104 can connect the privacy-based social content broadcast server 102 with one or more of the privacy-based social content broadcast clients 106 and 108 using some combination of wired technologies, such as twisted pair wire cabling, coaxial cabling, optical fiber cabling, or other cabling.

In the example of FIG. 1, the network 104 can also use some combination of wireless technologies. Wireless networks will typically include an internetworking unit (IWU) that interconnects wireless devices on the relevant one of the wireless networks with another network, such as a wired LAN. The IWU is sometimes referred to as a wireless access point (WAP). In the IEEE 802.11 standard, a WAP is also defined as a station. Thus, a station can be a non-WAP station or a WAP station. In a cellular network, the WAP is often referred to as a base station. Wireless networks can be implemented using any applicable technology, which can differ by network type or in other ways. The wireless networks can be of any appropriate size (e.g., metropolitan area network (MAN), personal area network (PAN), etc.). Broadband wireless MANs may or may not be compliant with IEEE 802.16, which is incorporated by reference. Wireless PANs may or may not be compliant with IEEE 802.15, which is incorporated by reference. The wireless networks 2404 can be identifiable by network type (e.g., 2G, 3G, Wi-Fi), service provider, WAP/base station identifier (e.g., Wi-Fi SSID, base station and sector ID), geographic location, or other identification criteria. The wireless networks may or may not be coupled together via an intermediate network. The intermediate network can include practically any type of communications network, such as, by way of example but not limitation, the Internet, a public switched telephone network (PSTN), or an infrastructure network (e.g., private LAN). The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web).

In the example of FIG. 1, one or more of the privacy-based social content broadcast clients 106 and 108 can include one or more computers, each of which can, in general, have an operating system and include datastores and engines. In this example, one or more of the privacy-based social content broadcast clients 106 and 108 can execute variable-layer content editing services inside a host application (i.e., can execute a browser plug-in in a web browser). The browser plug-in can provide an interface such as a graphical user interface (GUI) for a user to access the content editing services on the privacy-based social content broadcast server 102. The browser plug-in can include a GUI to display content and layers on the datastores in the privacy-based social content broadcast server 102. For instance, the browser plug-in can have display capabilities like the capabilities provided by proprietary commercially available plug-ins like Adobe™ Flash Player, QuickTime™, and Microsoft Silverlight™. The browser plug-in can also include an interface to execute functionalities on the engines in the privacy-based social content broadcast server 102.

In the example of FIG. 1, one or more of the privacy-based social content broadcast 106 and 108 can be a mobile device. A mobile device is a digital device having its power supplied by a battery and having network connectivity. The mobile device can include cellular telephony capabilities, and can comprise an iPhone manufactured by Apple™ or an Android™ device. The mobile device can incorporate an Internet browser, email functionalities, and text messaging (e.g., SMS messaging). In various embodiments, the mobile device is a computing tablet, such as an iPad manufactured by Apple™ or an Android™ tablet device.

In the example of FIG. 1, a device on which the privacy-based social content broadcast clients 106 and 108 is implemented can be implemented as a station. A station, as used herein, may be referred to as a device with a media access control (MAC) address and a physical layer (PHY) interface to the wireless medium that comply with, e.g., the IEEE 802.11 standard. A station can be described as “IEEE 802.11-compliant” when compliance with the IEEE 802.11 standard is intended to be explicit. (I.e., a device acts as described in at least a portion of the IEEE 802.11 standard.) One of ordinary skill in the relevant art would understand what the IEEE 802.11 standard comprises today and that the IEEE 802.11 standard can change over time, and would be expected to apply techniques described herein in compliance with future versions of the IEEE 802.11 standard if an applicable change is made. IEEE Std 802.11™-2007 (Revision of IEEE Std 802.11-1999) is incorporated by reference. IEEE 802.11k-2008, IEEE 802.11n-2009, IEEE 802.11p-2010, IEEE 802.11r-2008, IEEE 802.11w-2009, and IEEE 802.11y-2008 are also incorporated by reference.

In alternative embodiments, one or more wireless devices may comply with some other standard or no standard at all, and may have different interfaces to a wireless or other medium. It should be noted that not all standards refer to wireless devices as “stations,” but where the term is used herein, it should be understood that an analogous unit will be present on all applicable wireless networks. Thus, use of the term “station” should not be construed as limiting the scope of an embodiment that describes wireless devices as stations to a standard that explicitly uses the term, unless such a limitation is appropriate in the context of the discussion.

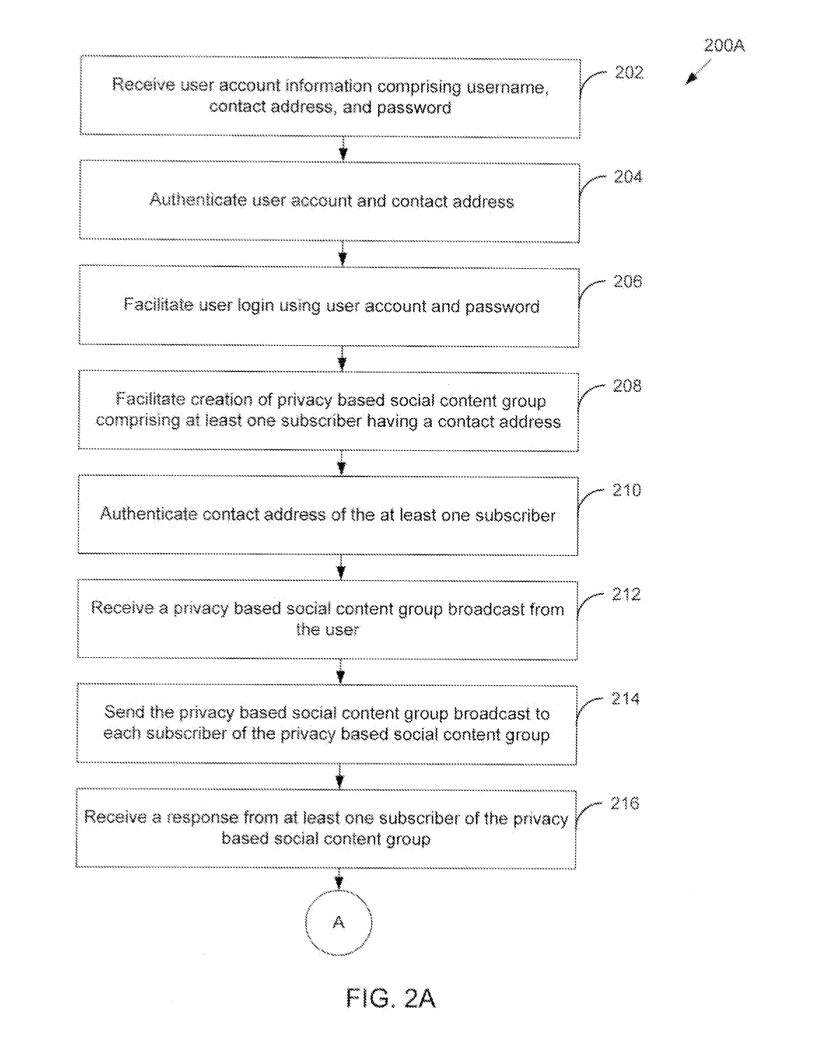

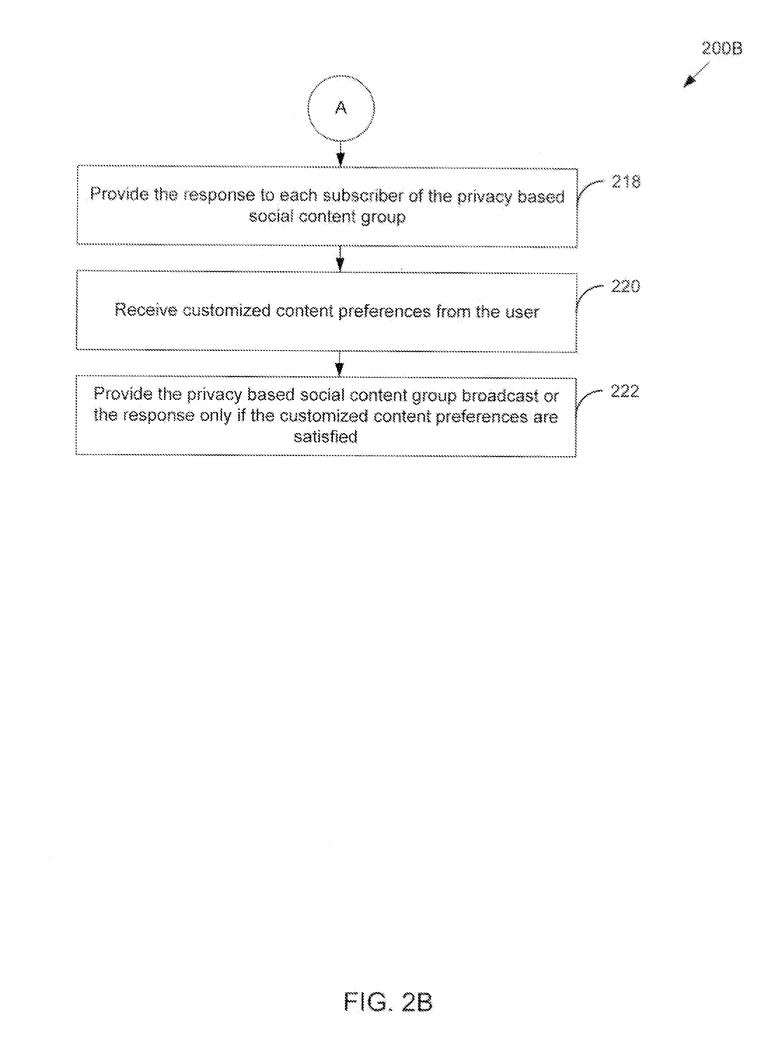

FIG. 2A shows a flowchart 200A of an example of a privacy-based social content broadcast method. In the example of FIG. 2A, the method 200A includes step 202, receiving user account information comprising a username, a contact address, and a password. The method 200A can continue to step 204, authenticating the user account and contact address (which in various embodiments can be a mobile phone number, an email address, or other contact address). The method 200A can then continue to step 206, facilitating user login using the user account and password. The method 200A can further continue to step 208, facilitating creation of a privacy based social content group comprising at least one subscriber having a contact address (which in various embodiments can be a mobile phone number, an email address, or other contact address). The method 200A can continue to step 210, authenticating the contact address of the at least one subscriber. The method 200A can continue to step 212, receiving a privacy based social content group broadcast from the user. The method 200A can then continue to step 214, sending the privacy based social content group broadcast to each subscriber of the privacy based social content group. The method 200A can then continue to step 216, receiving a response from at least one subscriber of the privacy based content group. In various embodiments, the response can take the form of a text message, an email, or a message using a privacy based social content service provider (e.g., Everyme). The method 200A can then continue to point A.

FIG. 2B shows a flowchart 200B of an example of a privacy-based social content broadcast method. The flowchart 200B can begin at point A. The flowchart 200B can continue to step 218, providing the response to each subscriber of the privacy based social content group. In various embodiments, the response can be provided via text message, email, or using a privacy based social content service provider (e.g., Everyme). In various embodiments, the response can be provided via the setting preferred by a given recipient. The method 200B can continue to step 220, receiving customized content preferences (e.g., “magic” preferences) from the user. The customized content preferences can be determined from the type of content that the user has received in the past or to which the user responds. The method 200B can continue to step 222, providing the privacy based social content group broadcast or the response only if the customized content preferences are satisfied.

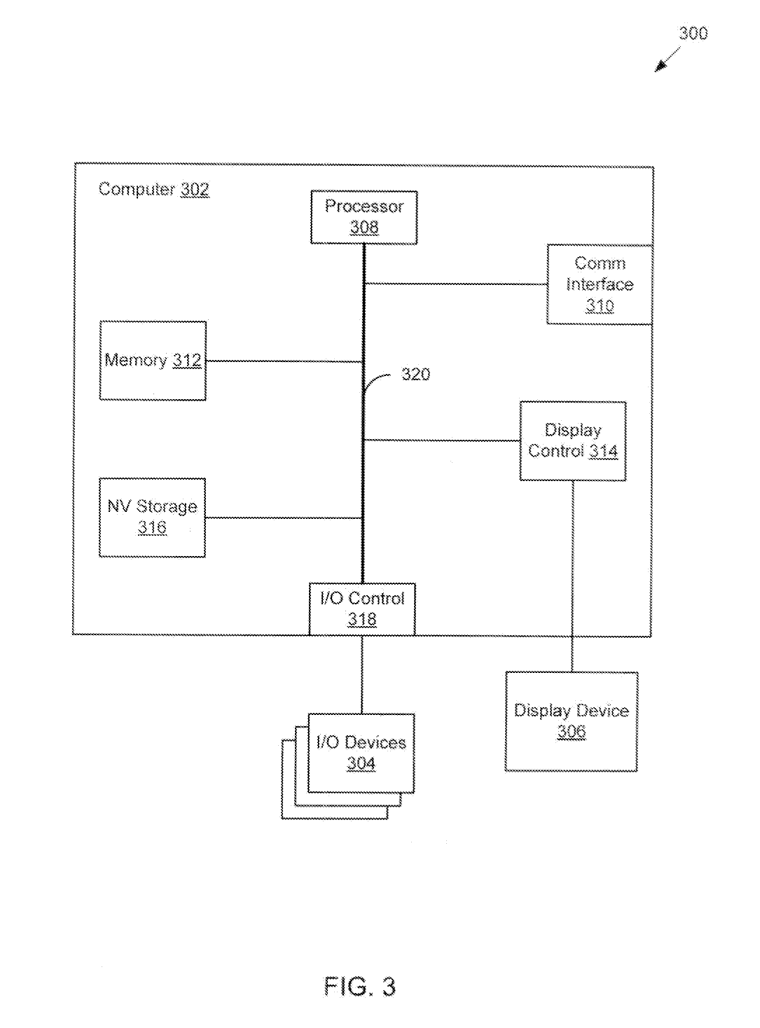

FIG. 3 shows a diagram of an example of a system on which techniques described herein can be implemented. The computer system 300 can be a conventional computer system that can be used as a client computer system, such as a wireless client or a workstation, or a server computer system. The computer system 300 includes a computer 302, I/O devices 304, and a display device 306. The computer 302 includes a processor 308, a communications interface 310, memory 312, display controller 314, non-volatile storage 316, and I/O controller 318. The computer 302 may be coupled to or include the I/O devices 304 and display device 306.

The computer 302 interfaces to external systems through the communications interface 310, which may include a modem or network interface. It will be appreciated that the communications interface 310 can be considered to be part of the computer system 300 or a part of the computer 302. The communications interface 310 can be an analog modem, ISDN modem, cable modem, token ring interface, satellite transmission interface (e.g. “direct PC”), or other interfaces for coupling a computer system to other computer systems.

The processor 308 may be, for example, a conventional microprocessor such as an Intel Pentium microprocessor or Motorola power PC microprocessor. The memory 312 is coupled to the processor 308 by a bus 820. The memory 312 can be Dynamic Random Access Memory (DRAM) and can also include Static RAM (SRAM). The bus 820 couples the processor 308 to the memory 312, also to the non-volatile storage 316, to the display controller 314, and to the I/O controller 318.

The I/O devices 304 can include a keyboard, disk drives, printers, a scanner, and other input and output devices, including a mouse or other pointing device. The display controller 314 may control in the conventional manner a display on the display device 306, which can be, for example, a cathode ray tube (CRT) or liquid crystal display (LCD). The display controller 314 and the I/O controller 318 can be implemented with conventional well known technology.

The non-volatile storage 316 is often a magnetic hard disk, an optical disk, or another form of storage for large amounts of data. Some of this data is often written, by a direct memory access process, into memory 312 during execution of software in the computer 302. One of skill in the art will immediately recognize that the terms “machine-readable medium” or “computer-readable medium” includes any type of storage device that is accessible by the processor 308 and also encompasses a carrier wave that encodes a data signal.

The computer system 300 is one example of many possible computer systems which have different architectures. For example, personal computers based on an Intel microprocessor often have multiple buses, one of which can be an I/O bus for the peripherals and one that directly connects the processor 308 and the memory 312 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 312 for execution by the processor 308. A Web TV system, which is known in the art, is also considered to be a computer system, but it may lack some of the features shown in FIG. 3, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described herein relate to apparatus for performing the operations. The apparatus can be specially constructed for the required purposes, or it can comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

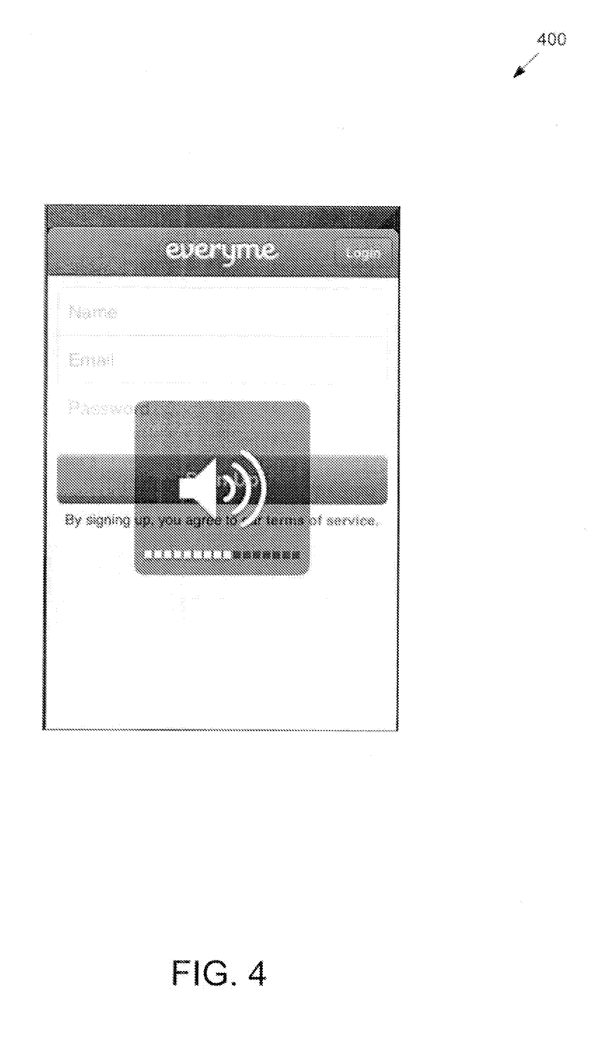

FIG. 4 shows an example of a login screen 400 for a privacy-based social content broadcast system. The login screen can reside on a privacy based social content broadcast client. In the example of FIG. 4, the login screen 400 includes a title bar, a name field, an email field, and a password field. The login screen 400 further includes a sign up button and a link to terms of service for the privacy-based social network content broadcast system. In the example of FIG. 4, the title bar can list a title of a privacy-based social content broadcast system service provider, here, Everyme. The title bar can also show the word “login” to signify that the service provider is accepting information from a new user who wishes to sign up to an account with a privacy-based social content broadcast system.

In the example of FIG. 4, the name field can accept a name of a new user. The name field can be configured to accept text input using input devices such as a keyboard or a touchscreen. The name field can be segmented to accept first, middle, and last names, suffixes, and titles. The email field is configured to accept an email address. The email field can be configured to run a script to parse whether a critical character (such as the character “@”), is entered in the field. The password field can be configured to accept a character string. In various embodiments, the password field can show specific characters as they are typed, and can redact or hide each character following a brief delay after the character is entered. In various embodiments, the login screen 400 can make the email field or the password field redundant (i.e., can replicate the relevant field) to ensure accurate entry. In the example of FIG. 4, the sign up button can act to transmit the information entered into the name field, the email field, and the password field. Once a user has clicked the sign up button, the information from the name field, the email field, and the password field, can be transmitted to a privacy based social content broadcast server. In the example of FIG. 4, the terms of service link can link a user to the relevant terms of service for the privacy based social content broadcast service provider.

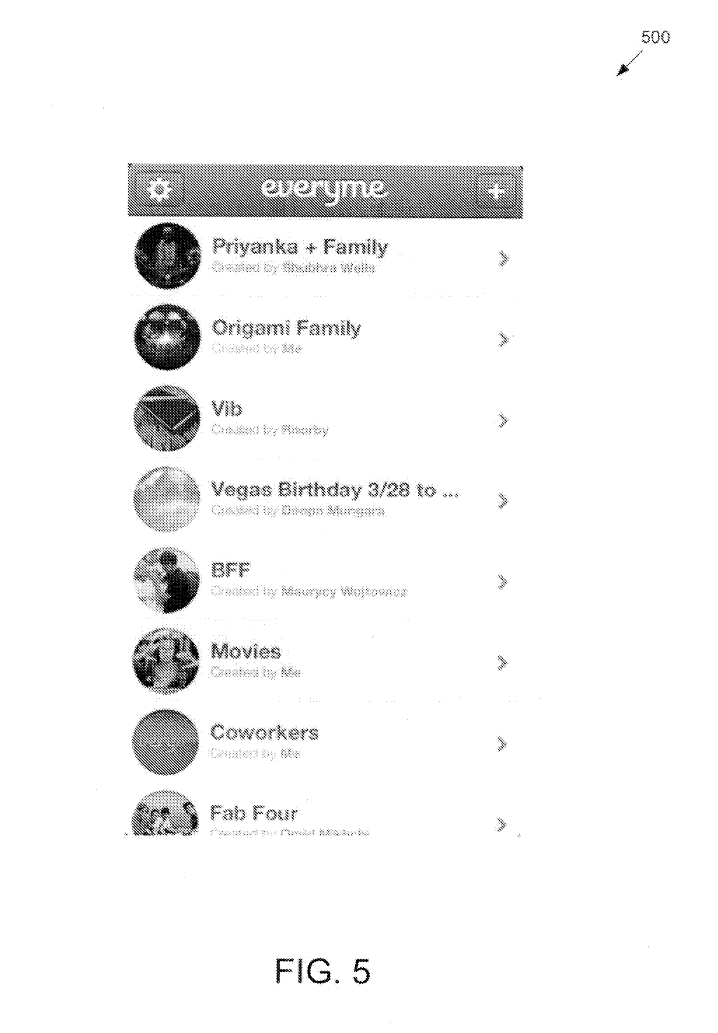

FIG. 5 shows an example of a user introduction screen 500. In the example of FIG. 5, the user introduction screen 500 can include a title bar, a link to privacy based social content broadcast categories, an introduction bubble, and a transition button. The title bar can include a settings button, a title of a privacy based social content broadcast service provider, and an add privacy based social content category button. The settings button can take a user to account settings for a privacy based social content broadcast service provider, discussed later. The title bar can also list the name of a privacy based social content broadcast service provider, here Everyme. The add privacy-based social content category button in the title bar can facilitate the addition of privacy based social content (e.g., a circle). By clicking the add privacy based social content category button, a user can add a privacy based content category (e.g., a “circle”) to his or her account.

In the example of FIG. 5, the link to the privacy based social content categories can include a link to one or more circles. As discussed, a circle is a private news feed for a user and a group of the user's friends. A circle can comprise a specific set of subscribers that a user has manually entered in and categorized. A circle can also comprise a subset of contacts taken from an email client, a phonebook, or a social media account. In various embodiments, a circle can comprise a set of subscribers having a specific or general association (e.g., friendship, alumni status, common experiences, or familial connections) with the user. The subscribers can receive news feeds from the user. The news feeds can include text, images, sounds, or video. The news feeds are private in that the contents of the news feeds are not broadcasted to people other than the user and his or her subscribers. Thus, the link provides a user with a high level of control over the specific subscribers that can receive his or her news feeds. In the example of FIG. 5, the introduction bubble can include text to help a new user navigate to a circle. On clicking the transition button, a user can be taken to a feedback circle screen.

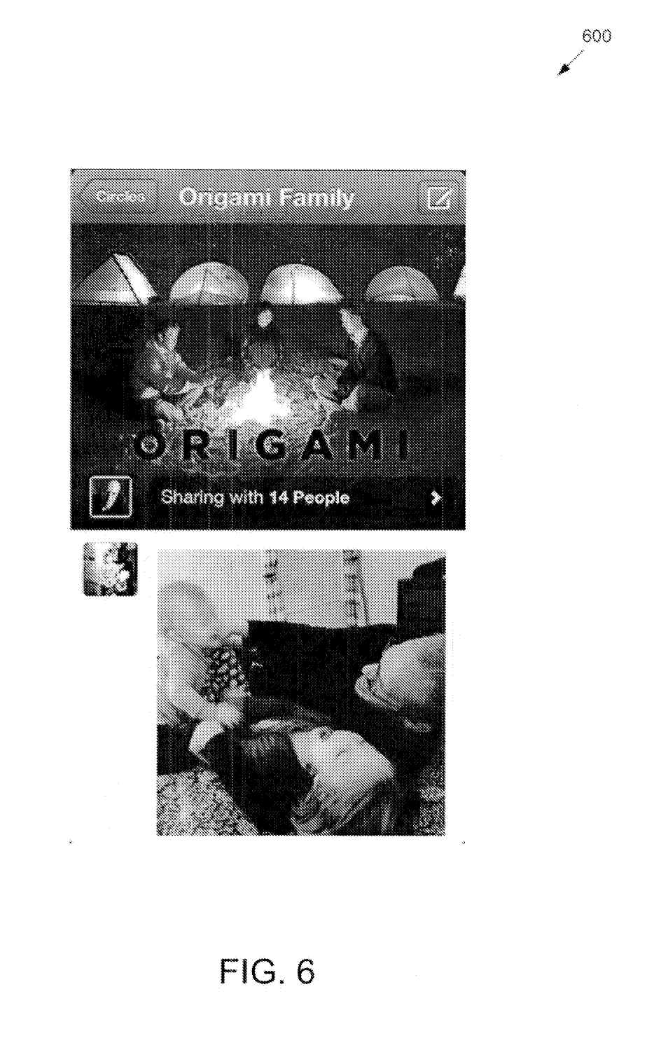

FIG. 6 shows an example of a screen 600 depicting a user feedback circle. The screen 600 can include a title bar, a list of subscribers, a subscriber post, and a comment field. In the example of FIG. 6, the title bar can include a link button, a screen title, and a compose button. The link button can allow the user to return to another screen. The screen title can provide a context for the user's experience in privacy based social content broadcast system. Here, the user is a subscriber to a feedback circle, and the screen title provides the word “Feedback” to indicate that the user is subscribing to a private news feed from the feedback circle. The compose button allows the user/subscriber to post a message to the feedback circle. The list of subscribers shows that the feedback circle is shared among six people. The subscriber post shows a private news post from another member of the feedback circle. For example, the subscriber post in FIG. 6 shows a request by a user named “Oliver” for subscribers to share their individual news stories. The comment field allows the subscriber to directly comment on the post by the user “Oliver.”

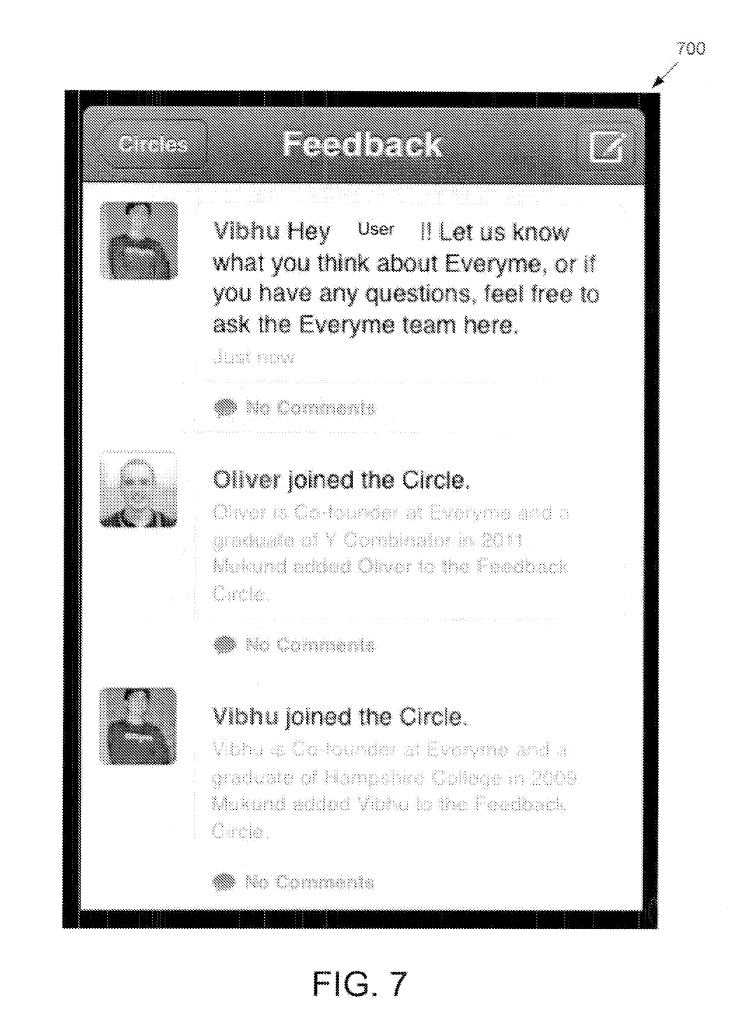

FIG. 7 shows an example of a screen 700 depicting a user feedback circle. In this example, the screen 700 is a continuation of the screen 600 of FIG. 6, and a user can navigate to the screen 700 from the screen 600 by scrolling down from the screen 600. In the example of FIG. 7, the screen 700 can include a title bar and a news feed. The title bar of the screen 700 can be similar to the title bar of the screen 600 in FIG. 6.

The news feed on the screen 700 can include posts from subscribers to the feedback circle. In this example, the screen 700 shows a first news post from a user named “Vibhu.” The first news post solicits questions from the specific subscriber, here “User.” The news feed further includes a second news post indicating that “Oliver” joined the feedback circle. The second news post details Oliver's background and the fact that the specific subscriber added Oliver to the feedback circle. The screen 700 can also include a third news post from the subscriber Vibhu. The third news feed can show Vibhu's background and can state the fact that the specific subscriber added Vibhu to the feedback circle.

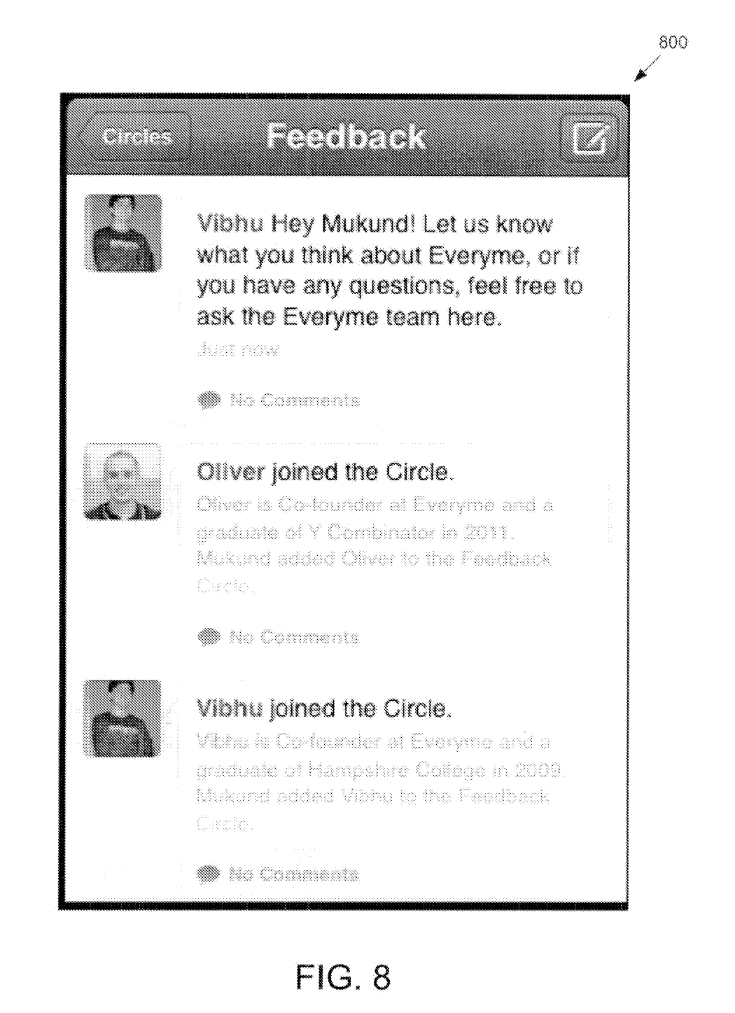

FIG. 8 shows an example of a screen 800 depicting a user feedback circle. In this example, the screen 800 is a continuation of the screen 700 of FIG. 7, and a user can navigate to the screen 800 from the screen 700 by scrolling down from the screen 700. In this example, the screen 800 can include a first news post by Maurycy, a second news post by a user Cortland, and a third news post by a user Scott. Each of the first news post, the second news post, and the third news post can include background information of a user and the fact that the specific subscriber added those users to the feedback circle.

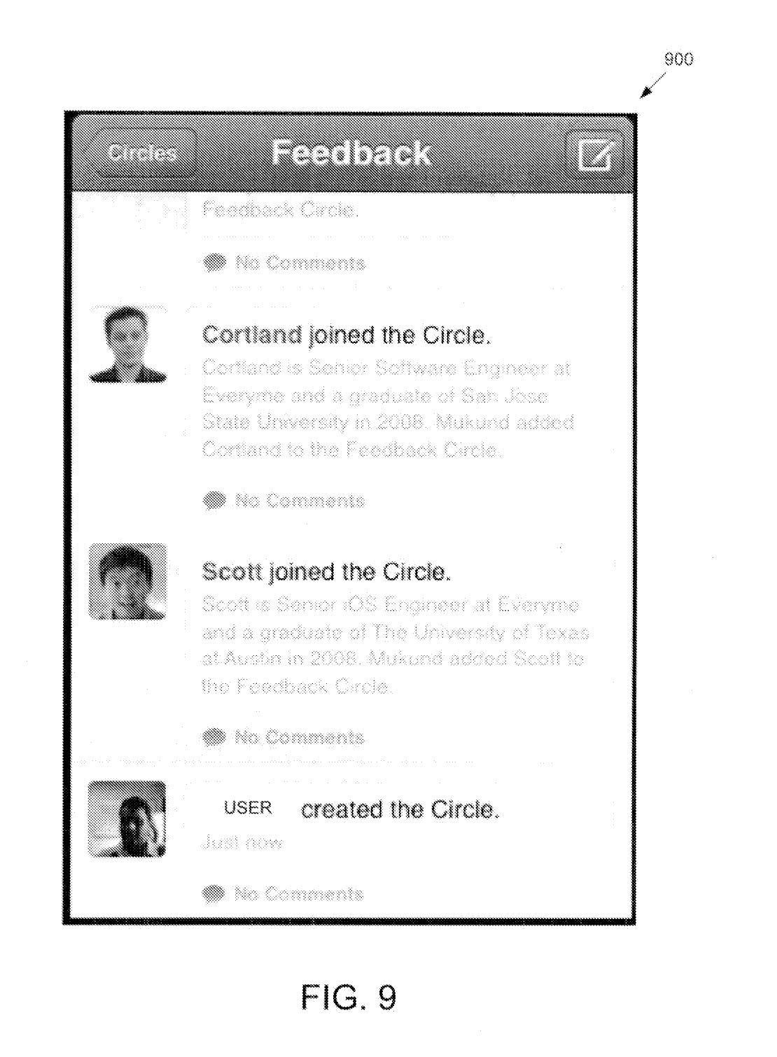

FIG. 9 shows an example of a screen 900 depicting a user feedback circle. In this example, the screen 900 is a continuation of the screen 800 of FIG. 8, and a user can navigate to the screen 900 from the screen 800 by scrolling down from the screen 800. In this example, the screen 900 can include a first news post by Maurycy, a second news post by a user Cortland, and a third news post by a user Scott. Each of the first news post, the second news post, and the third news post can include background information of a user and the fact that the specific subscriber added those users to the feedback circle. Further, the screen 900 can include the fact that the specific subscriber created the feedback circle.

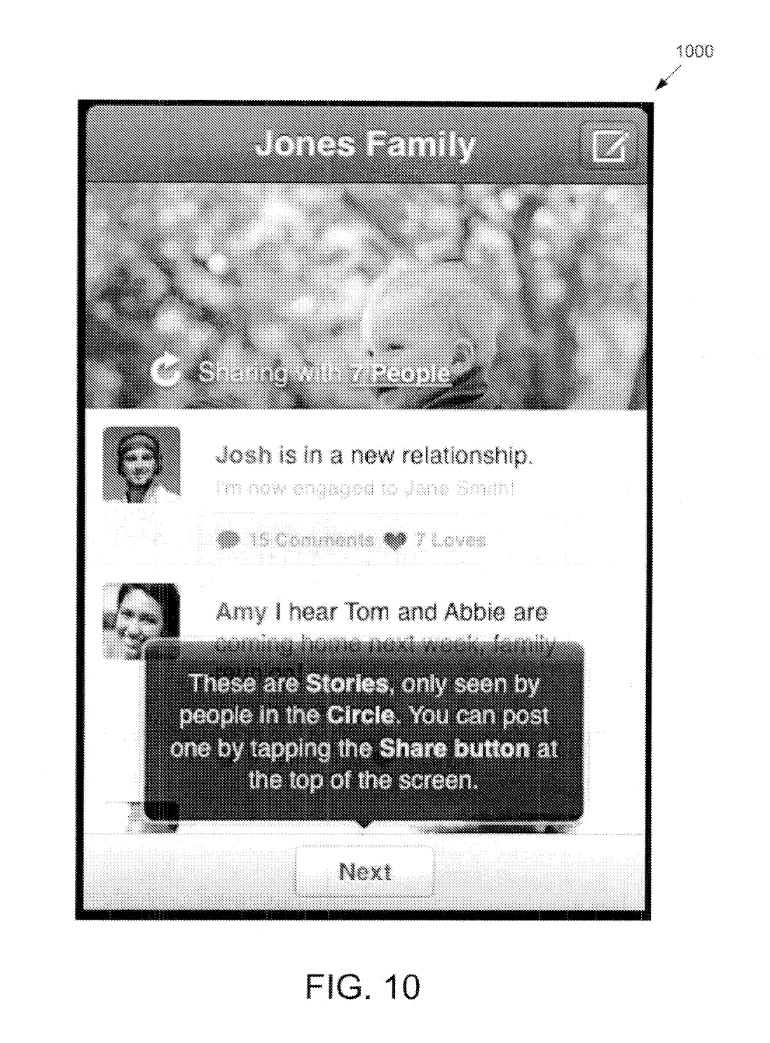

FIG. 10 shows an example of a screen 1000 depicting a story shared by a circle. In the example of FIG. 10, the screen 1000 can include a title bar, a news feed, an introduction bubble, and a transition button. In the example of FIG. 10, the title bar can include a title of a privacy based social network content category, here, the “Jones Family.” The title bar can also include a compose button to facilitate a subscriber's broadcasting of privacy-based social content to the news feed. In the example of FIG. 10, the news feed can include specific news posts from subscribers to the news feed. For instance, the news feed can show that seven subscribers have subscribed to the Jones Family news feed. The news feed can show that a user “Josh” is in a new relationship, and the comments of a user named “Amy.” Advantageously, even intimate stories and moments (such as Josh's engagement) can be shared with a limited set of subscribers and need not be broadcasted to the outside world without the permissions subscribers to this specific news feed. In the example of FIG. 10, the introduction bubble provides an introduction to the concept of stories. Consistent with the privacy based social content features, stories include content that can only be seen by people in a specific circle, here, the Jones Family circle. In this example, a subscriber can share stories by tapping the “share” button (i.e., the compose button) at the top of the screen, i.e., in the title bar. The transition button lets the user access members of the Jones Family circle.

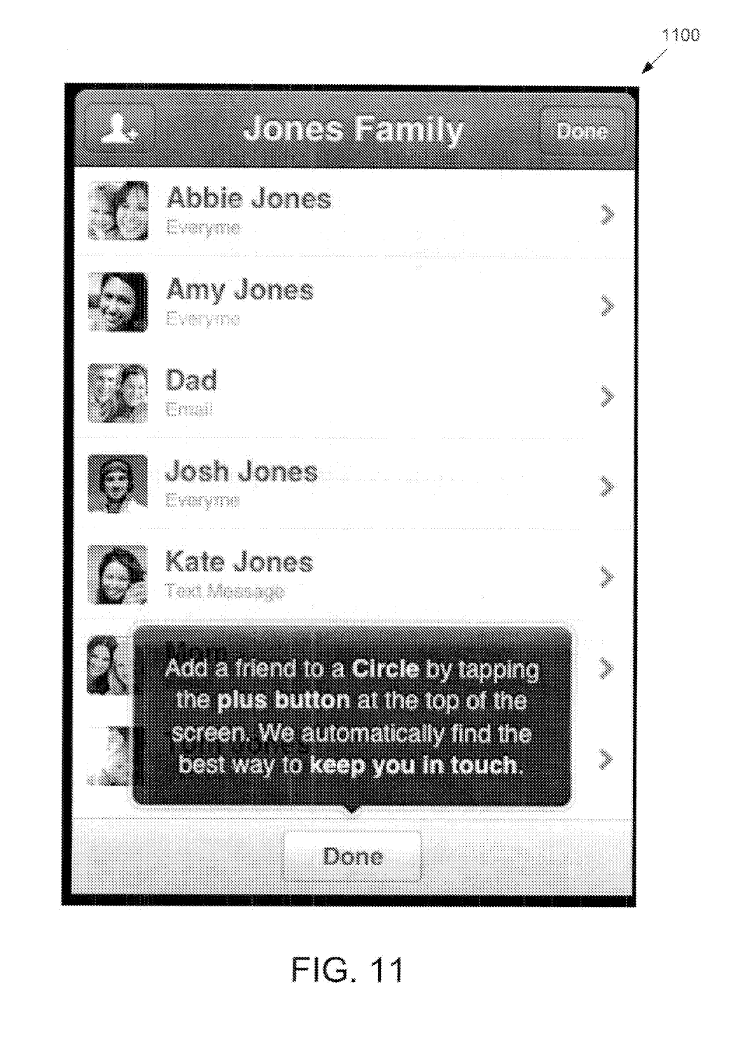

FIG. 11 shows an example of a screen 1100 depicting a family circle. In an example, a subscriber can access the screen 1100 by clicking the transition screen, shown in screen 1000 of FIG. 10. In the example of FIG. 11, the screen 1100 can include a title bar, a user list, an introduction bubble, and a transition button. The title bar can include an add user button, a title, and a transition button. The add user button lets a subscriber add a user to the circle, e.g., the Jones Family circle. The subscriber can add the contact information of a member satisfying a predetermined set of criteria such as belonging to a family. The title provides a name for the circle. The transition button allows the subscriber to exit the screen 1100.

In the example of FIG. 11, the user list can include a list of subscribers. In this example, the subscribers are family members, including Abbie Jones, Amy Jones, Dad, Josh Jones (the member who was just engaged), Kate Jones, and others. The example of FIG. 11 can also show a connection medium associated with each user. As used herein, a connection medium is a method of communication that a user or a subscriber can use to access subscribers in a subscriber list. In this example, the connection medium associated with Abbie Jones, Amy Jones, and Josh Jones is Everyme. This means that a message to the Jones Family news feed will go to Abbie Jones, Amy Jones, and Josh Jones through a proprietary social network, here provided by the service provider Everyme. In some embodiments, the Abbie Jones, Amy Jones, and Josh Jones can receive the news feed to the Everyme application executed in their web browsers or running on their mobile devices. In the example of FIG. 11, the connection medium associated with Dad is email. This means that a message to the Jones Family feed will go to Dad through email. Further, in this example, the connection associated with Kate Jones is text message. This means that a message to Jones Family will go to Kate Jones through a text message (e.g., an SMS message) to Kate Jones's mobile phone. In the example of FIG. 11, the introduction bubble can instruct a subscriber to add a friend to a circle by tapping on the plus button (i.e., the add user button) at the top of the screen.

Advantageously, in some embodiments, the service provider's application can find the best way for a user to keep in touch with subscribers of the news feed. The best way to keep in touch can include the most commonly accessed medium of a subscriber or can include the way a subscriber indicated that they wished to be contacted. Thus, in some embodiments, the service provider can determine that Abbie Jones, Amy Jones, and Josh Jones have downloaded the Everyme application. Therefore, the service provider can provide news feeds to Abbie Jones, Amy Jones, and Josh Jones using Everyme because these users have indicated a degree of familiarity with the proprietary application by their use. The service provider can similarly note that the user Dad is most proficient at email, while the user Kate Jones is most proficient at text messaging. In various embodiments, however, the service provider can base the connection medium on a subscriber's expressed preference. For instance, Abbie Jones, Amy Jones, and Josh Jones may have indicated, when initially subscribing to the news feed, that they wish to be contacted through the proprietary application. Dad may have previously marked a preference to be contacted through email while Kate Jones may have expressed a preference to be contacted through text messages. In the example of FIG. 11, the transition button can facilitate exiting the screen 1100.

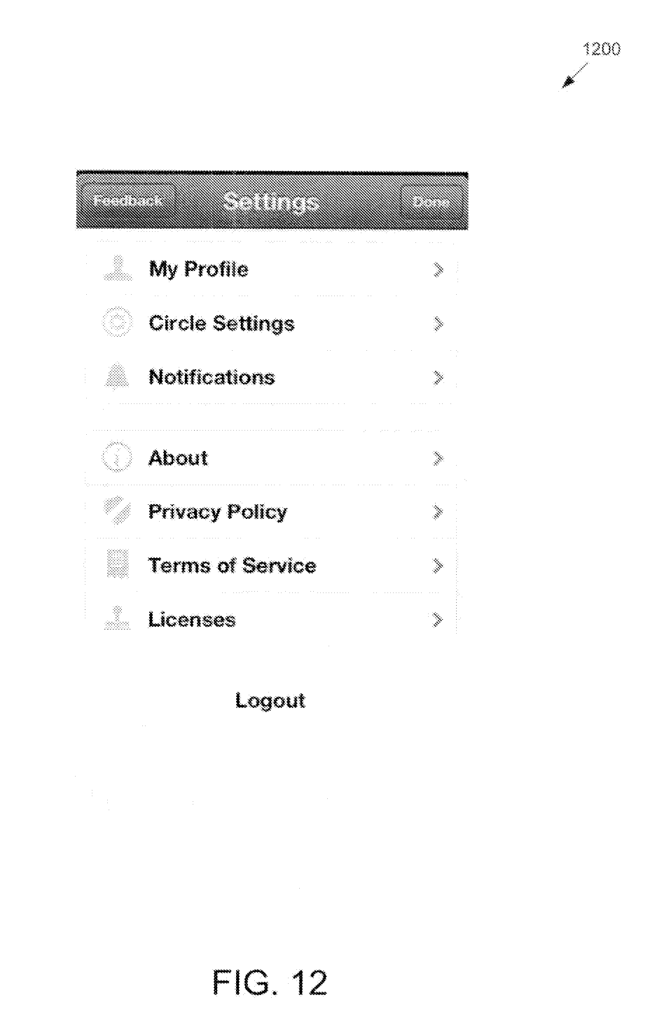

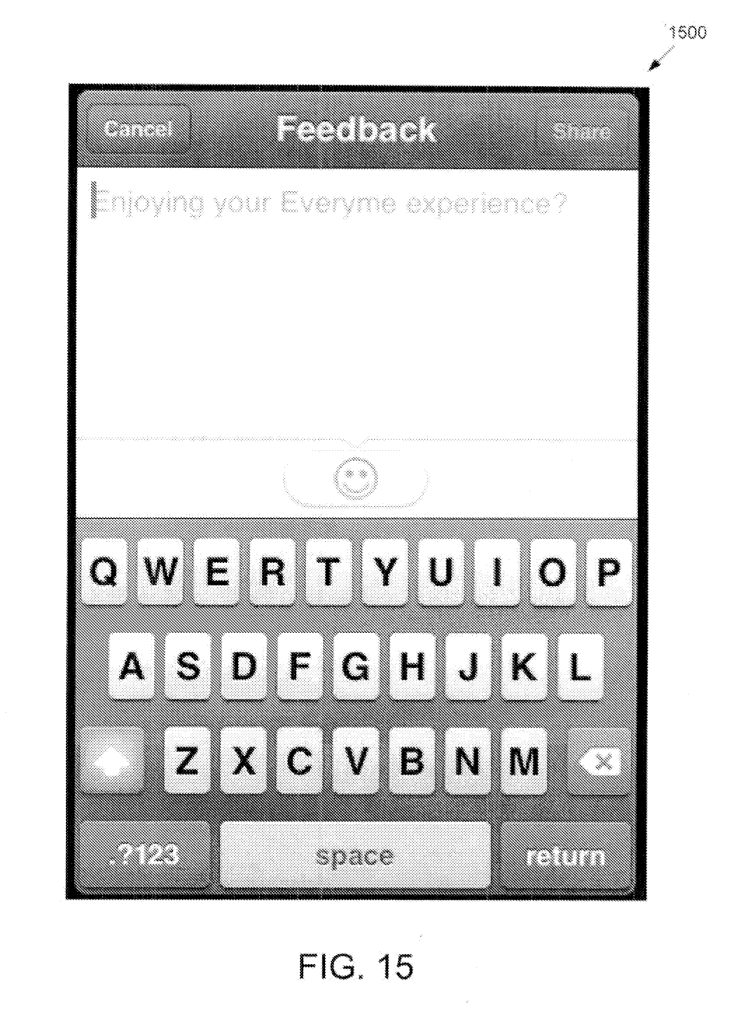

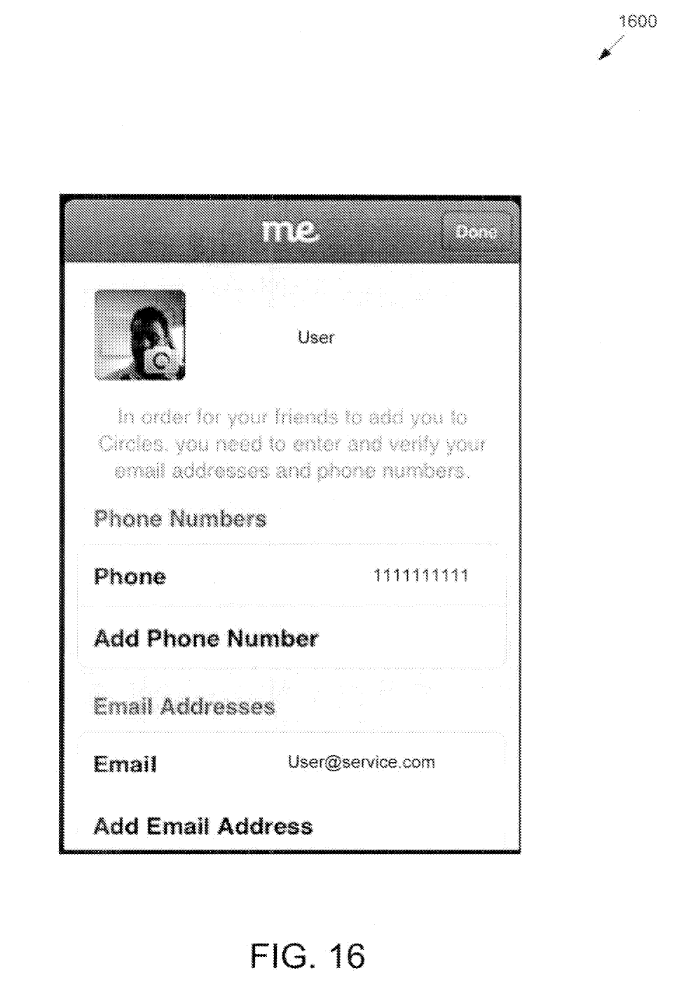

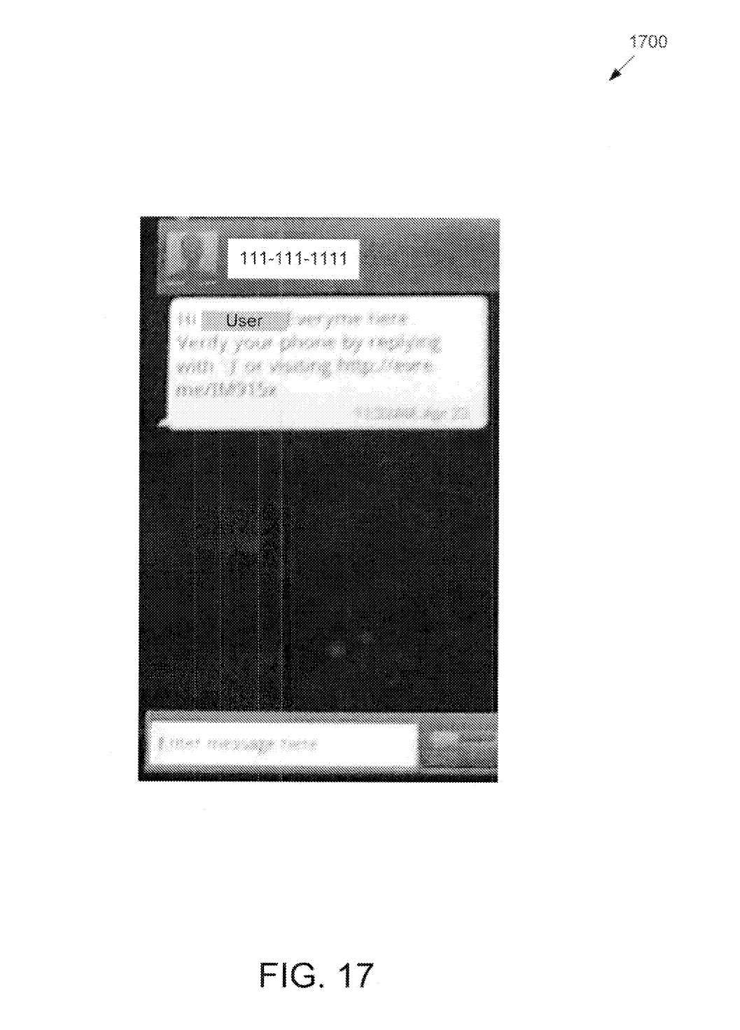

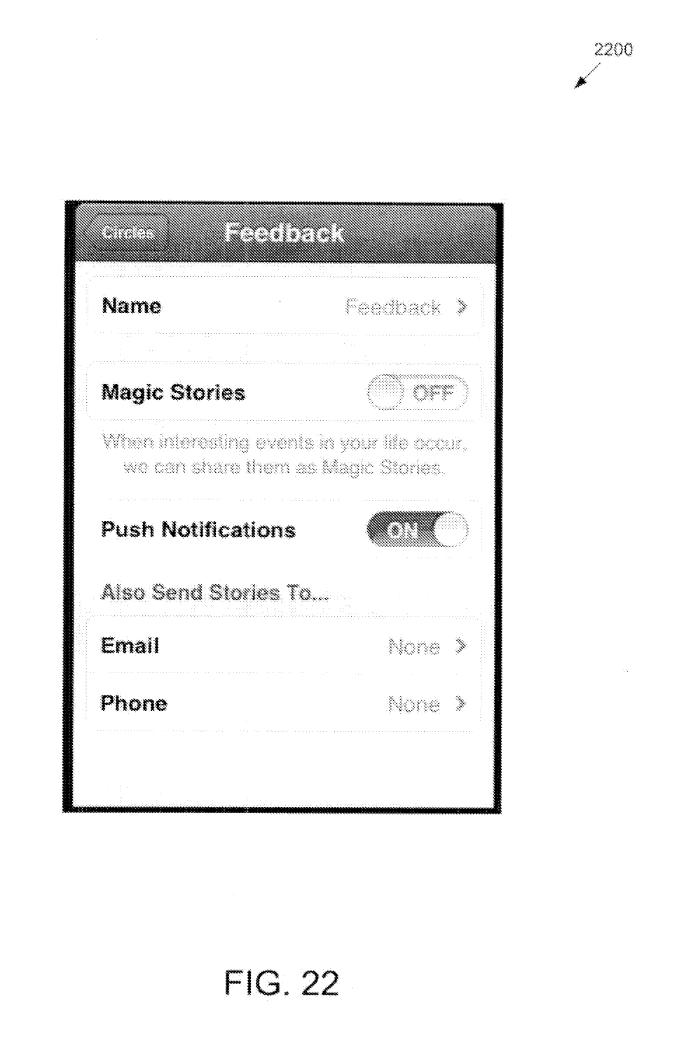

FIG. 12 shows an example of a screen 1200 depicting user settings and social media settings. In the example of FIG. 12, the screen 1200 can include a title bar, a profile setting link, a push notifications settings link, a circle settings link. The title bar can include a feedback button, a title, and an exit button. In this example, a user's clicking the feedback button can direct a user to a screen such as the screen 1500 in FIG. 15. Clicking the profile setting link can direct a user to a screen such as the screen 1600 in FIG. 16. Clicking the push notifications setting link can direct a user to a screen such as the screen 1700 in FIG. 17. Clicking the circle settings link can direct a user to a screen such as the screen 2200 in FIG. 22.

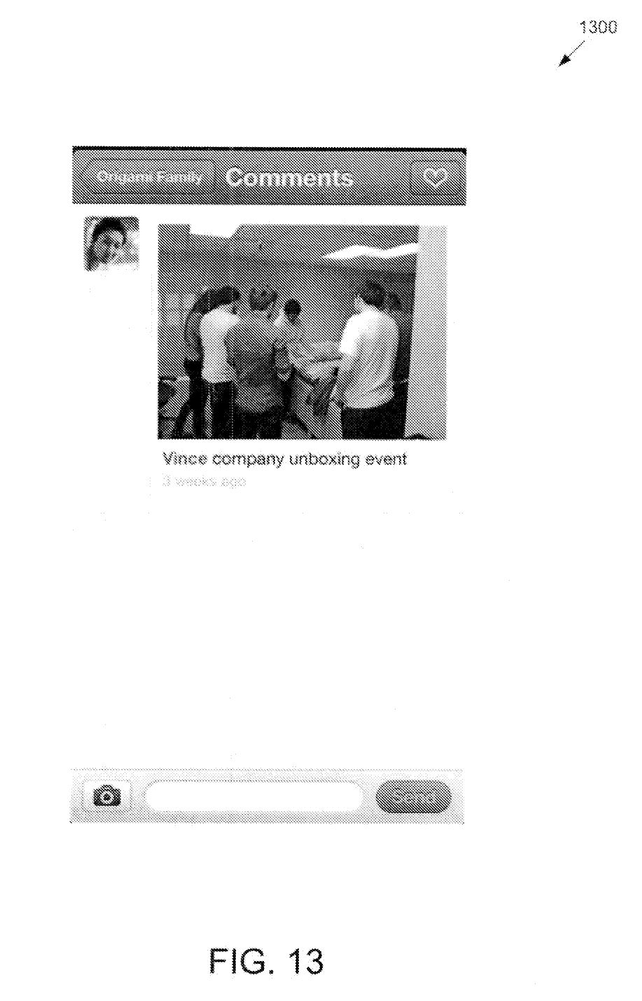

FIG. 13 shows an example of a screen 1300 depicting user content of users in a user circle group. The screen 1300 can include a display of user content that is either a broadcast or a response to a broadcast that is input by one of the users in the user circle. The user content, can be a photo and a caption, such as the content shown in FIG. 13. The screen can include a text field. A user can therefore input user content in the form of text through the text field. The text can be a user's response to user content that is either a broadcast or another users response to a broadcast.

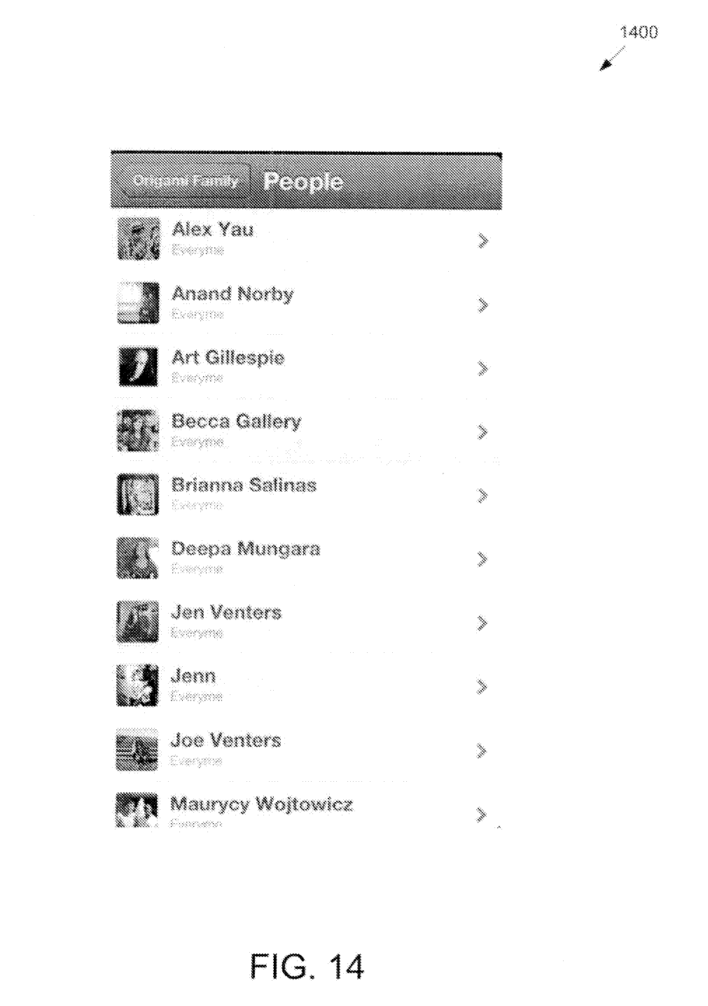

FIG. 14 shows an example of a screen 1400 depicting a subscriber list associated with a personal circle. The screen 1400 can include a list of different subscribers that are associated with a personal circle. The screen can include a title bar that contains a name of the personal circle. Each subscriber can be represented by a picture and ID information that is associated with each subscriber. The ID information can be the relationship that the subscriber has to a specific user who is part of the personal circle. The subscriber information can also be implemented as a link to a subscriber information screen. The subscriber information screen can include additional information about the subscriber that is not shown on the screen 1400, such as the contact information of the subscriber.

FIG. 15 shows an example of a screen 1500 depicting a post to a user feedback circle. In the example of FIG. 15, the screen 1500 includes a title bar containing a cancel button, a title, and a share button. The screen 1500 also contains a text field, here prewritten with the words “Enjoying your Everyme experience?” In the example of FIG. 15, a user can write his or her experience into the text field using an input mechanism, such as the touch screen keyboard depicted at the bottom of the screen 1500 in FIG. 15.

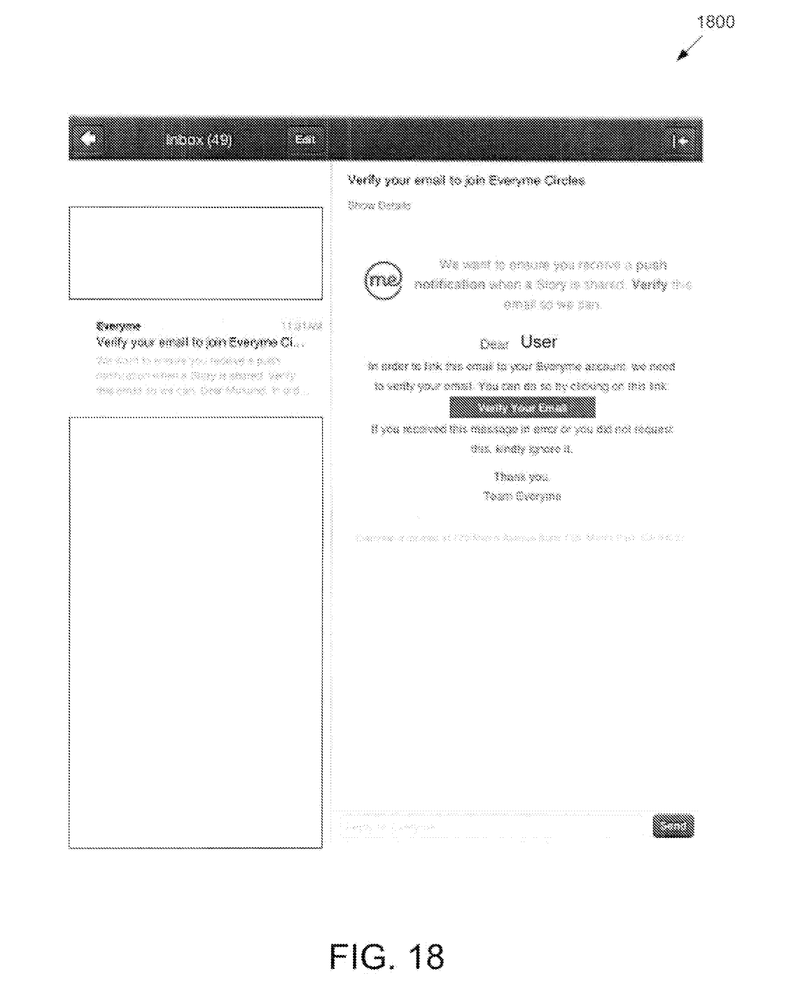

FIG. 16 shows an example of a screen 1600 depicting personal contact verification settings. In the example of FIG. 16, the screen 1600 can include a title bar which in turn includes the logo “me” and the button labeled “Done.” The screen 1600 can also include a personal icon, which can be a graphical avatar or a user-uploaded photo. The screen 1600 further can include a user name and a notification that a user needs to enter and verify email addresses and phone numbers in order for the user's friends to add the user to a circle. In the example of FIG. 16, the screen 1600 can list phone numbers and email addresses for the user. In this example, the user has entered one phone number and one email address. Once the user has entered his or her phone number and email address, the user can click the “Done” button at the top right of the title bar. In some embodiments, the privacy based social content service provider can verify the user's identity by sending verification messages to the entered phone number and email address. Thus, clicking the “Done” button in the screen 1600 can direct a user to the screens of FIGS. 17 and 18.

FIG. 17 shows an example of a screen 1700 depicting a Short Messaging Service (SMS) authorization. In the example of FIG. 17, the screen 1700 can include an originating SMS address, and an initiation message. In the example of FIG. 17, the initiation message includes a request to verify the receiving phone by replying with the characters “:)” or by visiting an authorization website. A user can therefore verify his or her mobile phone number by a reply text message or on the authorization website. Once the user has responded to this verification message, the privacy based social content service provider can provide the mobile phone associated with the SMS message push notifications of stories relating to a news feed for a circle.

FIG. 18 shows an example of a screen 1800 depicting an email authorization. In the example of FIG. 18, the screen 1800 contains an Internet browser window containing a location bar and a content pane. The content pane includes an email inbox. In the example of FIG. 18, the email inbox includes a verification email from a privacy based social content service provider, e.g., Everyme. The verification email notifies the user that the service provider wants to ensure the user requested a push notification when a story is created, and contains a button that directs the user to a verification link. Once the user has responded to this verification message, the privacy based social content service provider can provide the email address push notifications of stories relating to a news feed for a circle.

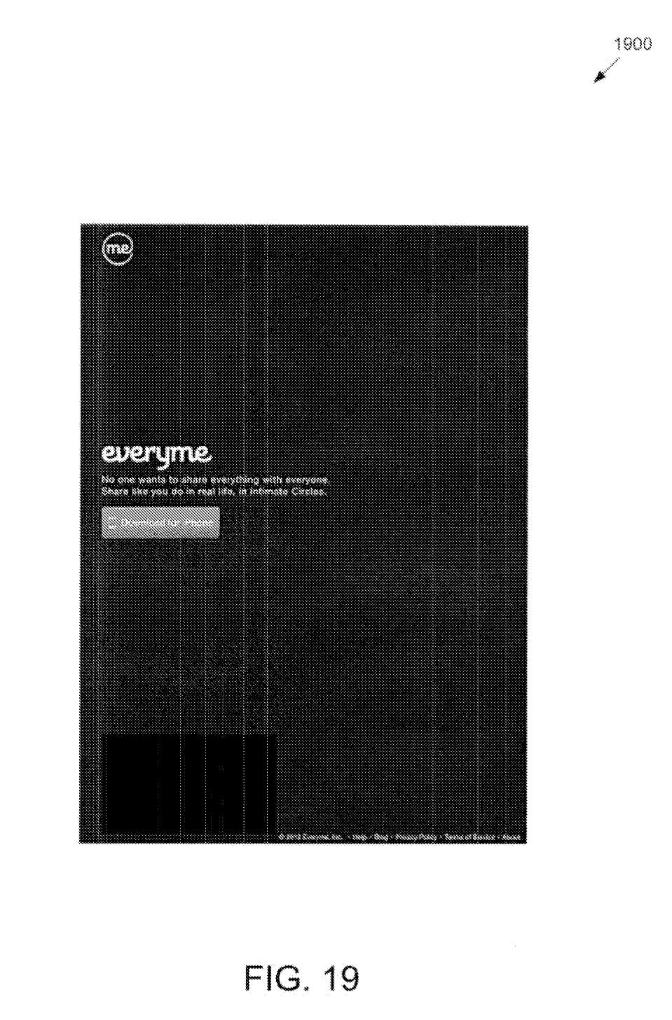

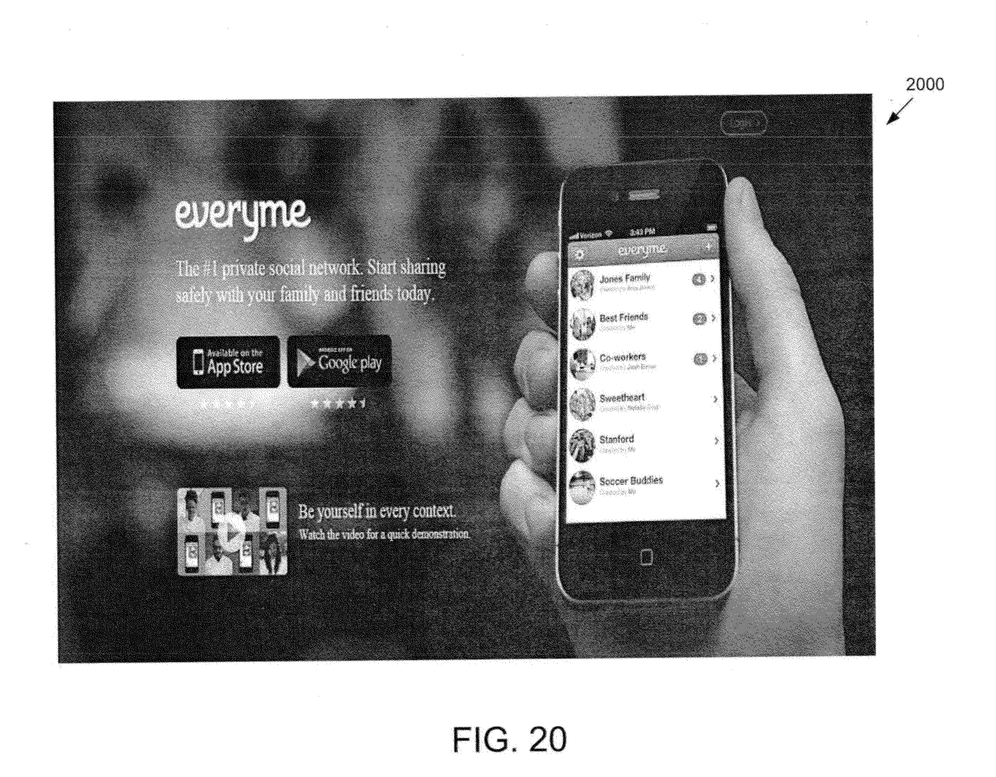

FIG. 19 shows an example of a screen 1900 depicting a home screen of a privacy-based social content broadcast service provider. In the example of FIG. 19, the privacy-based social content broadcast service provider is Everyme, and the website is everyme.com. A user may be directed to the screen 1900 after verifying his or her email address (as discussed in relation to FIG. 18) or verifying his or her phone number (as discussed in relation to FIG. 17). FIG. 20 similarly shows an example of a screen 2000 depicting a home screen of a privacy-based social content broadcast service provider. In the example of FIG. 20, the privacy-based social content broadcast service provider is Everyme, and the website is everyme.com. A user may be directed to the screen 2000 after verifying his or her email address (as discussed in relation to FIG. 18) or verifying his or phone number (as discussed in relation to FIG. 17).

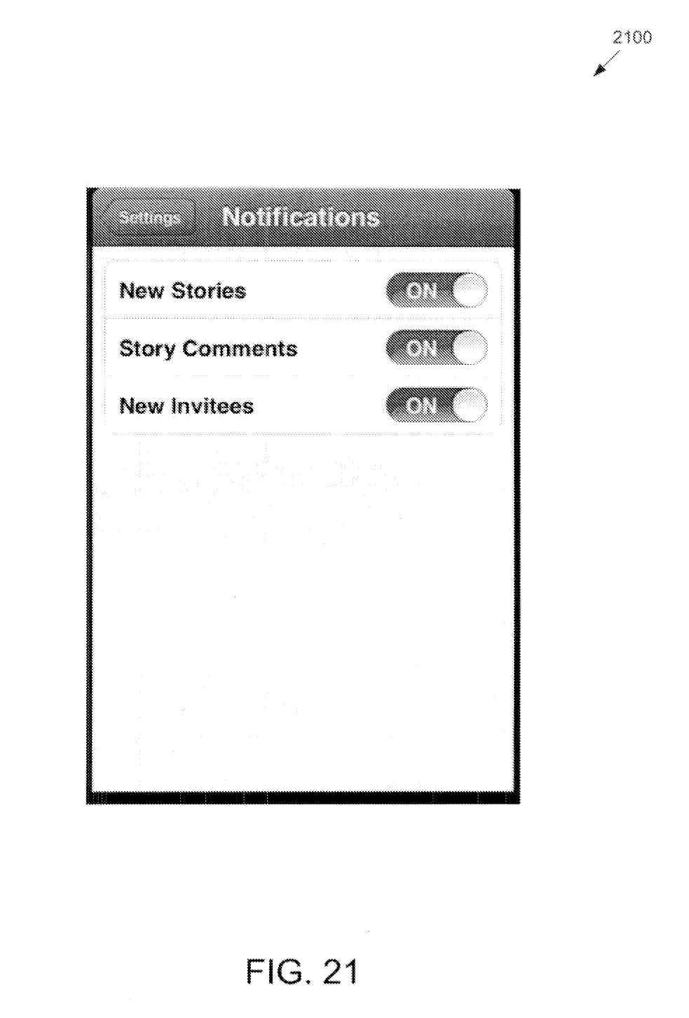

FIG. 21 shows an example of a screen 2100 depicting notification settings. In the example of FIG. 21, the screen 2100 can include a title bar containing a settings button and a title (here “Notifications”). The screen 2100 can also include radio buttons that allow a user to turn specific notifications on or off. In this example, the screen 2100 contains a New Stories radio button that allows a user to turn on or off notifications about New Stories from members of the user's circle, a Story Comments button that allows a user to turn on or off notifications about Story Comments from members of the user's circle, and a New Invitees button that allow a user to turn on or off notifications about New Invitees to the user's circles. As a result, a privacy based social content service provider can allow a user to control the amount and frequency of notifications regarding updates to the user's circles.

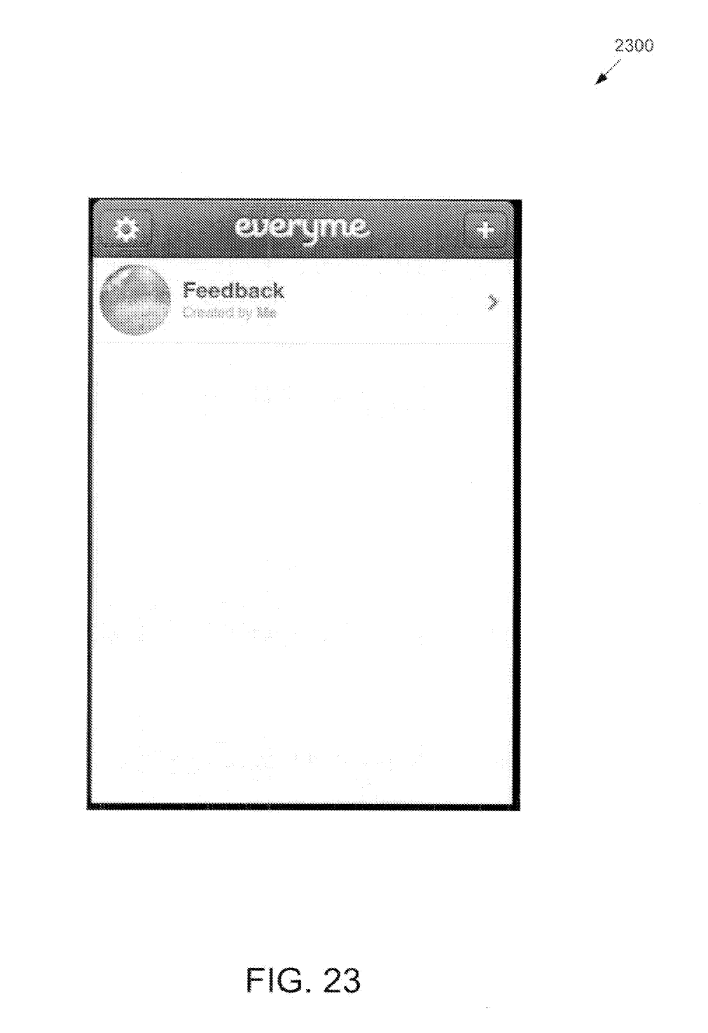

FIG. 22 shows an example of a screen 2200 depicting settings for a user feedback circle. In the example of FIG. 22, the screen 2200 includes a title bar containing a circles button and a title. The screen 2200 can further include a name button, a magic stories button, a push notification settings button, a first alternate destinations button and a second alternate destinations button. The circles button can return the user to the list of the user's circles (see, e.g., FIG. 23). The magic stories button can turn on or off magic stories. As used herein, magic stories are stories related to events of particular importance in the privacy based social content system. The magic stories can be shared with a circle's subscribers as the magic stories are posted. In the example of FIG. 22, the push notifications button can be set to turn on or off push notifications. Push notifications are notifications that go to all subscribers of a circle as the notifications are published by the circle. The push notifications enable broadcasting of content relevant to the circle to all subscribers of the circle without the subscribers having to check for updates or manually send updates to one another.

In the example of FIG. 22, the first alternate destinations button includes the capability to send stories to a subscriber's email address. The email address can be a verified email address associated with the subscriber's account with the privacy based social content service provider. Further, the second alternate destinations button can include the capability to send stories to a subscriber's mobile phone. The mobile phone number can be a verified mobile phone associated with the subscriber's account with the privacy based social content service provider.

FIG. 23 shows an example of a screen 2300 depicting settings for a user feedback circle. In the example of FIG. 23, the screen 2300 can include a title bar comprising a settings button, a title, and an add circle button. The screen 2300 can also include a list of circles, shown in FIG. 23 as comprising the feedback circle. The user can add a new circle by clicking on the add button on the top right hand corner of the screen 2300. The add circle button can take the user a new screen that facilitates the addition of a circle compatible with a privacy based social content service provider.

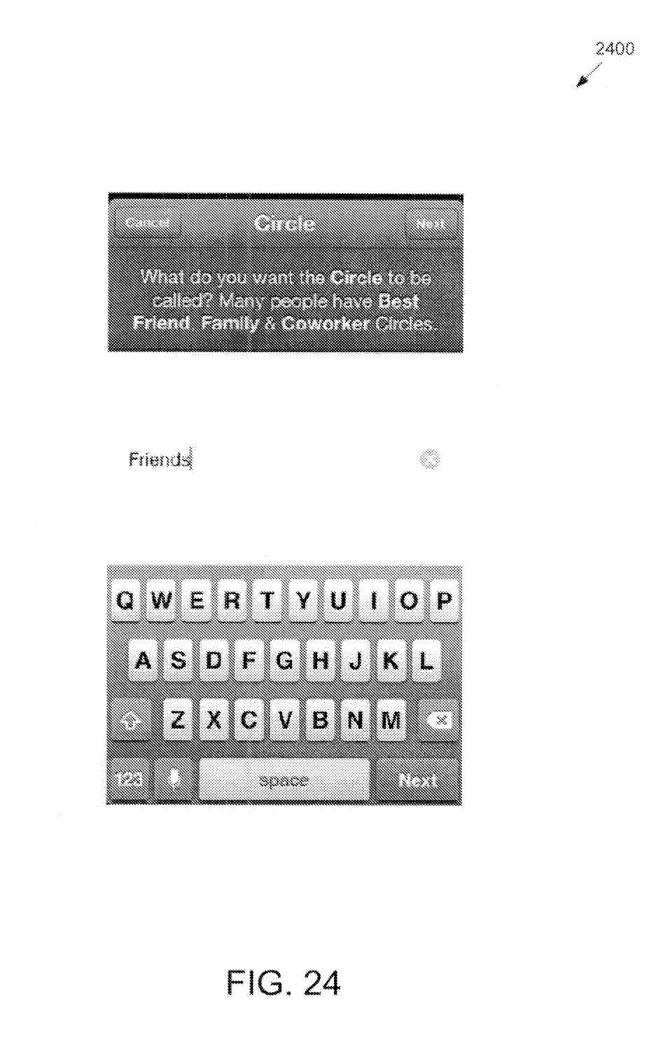

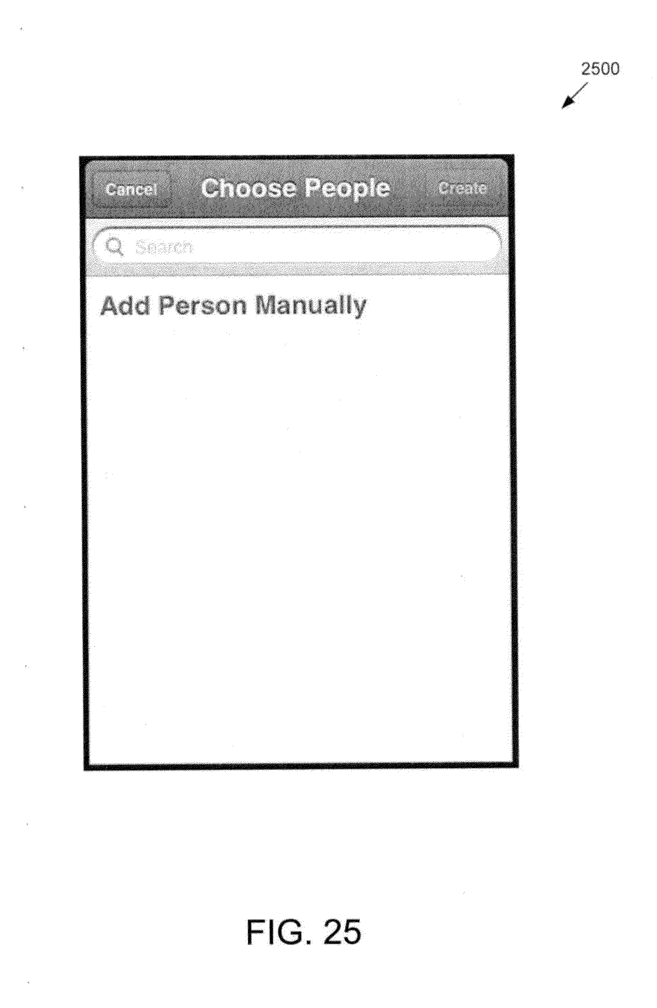

FIG. 24 shows an example of a screen 2700 depicting settings to create a personal circle. As discussed, a personal circle is a private place for a user and a group of friends to share stories with one another. Once the circle is created, the user and his or her group of friends can be subscribers to the circle and its related updates. In the example of FIG. 24, the screen 2400 can include a title bar containing a cancel button, a title (here “Circle”) and a next button. The screen 2400 can further contain a circle name field to allow a user to enter a name of a new circle that the user desires to create. In various embodiments, the circle name field can accept input from a keyboard or a touchscreen interface. Here, the user is attempting to create a new circle labeled “Old Work Friends.” The new circle can comprise a list of alumni of a prior workplace of the user. The alumni list and the user can form a subscriber list of the new circle. The user can click the next button on the top right hand corner of the screen 2400 so that a privacy based social content service provider can add people to the new circle. In this example, the user can be directed to a screen such as the screen 2500 in FIG. 25.

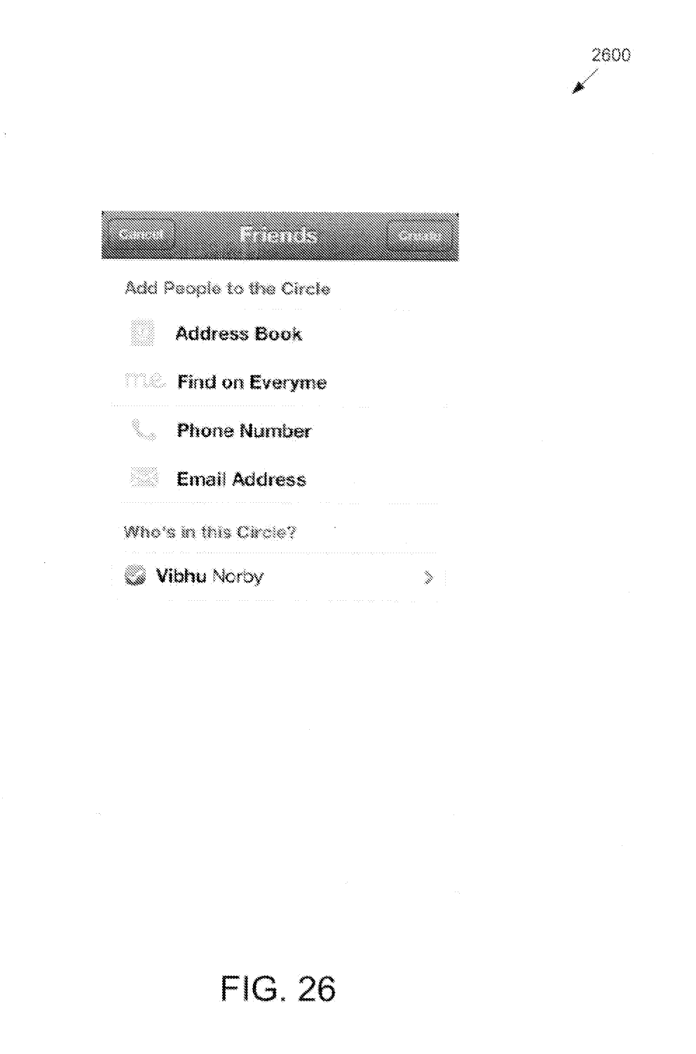

FIG. 25 shows an example of a screen 2500 depicting settings to add a subscriber to a personal circle. In the example of FIG. 25, the screen 2500 can include a title bar containing a cancel button, a title (here “Choose People”) and a create button. The screen 2500 can also contain a search field to search for people associated with the user. In some embodiments, the search field can accept text to search a database aggregated from the user's personal address book or the user's address books from his or her social networking sites. In the example of FIG. 25, the screen 2800 further contains a manual addition button. When the user selects the manual addition button, the privacy based social content service provider can present a screen asking whether the user wishes to add a phone number or an email address. For instance, the privacy based social content service provider can present the user with the screen 2600 of FIG. 26.

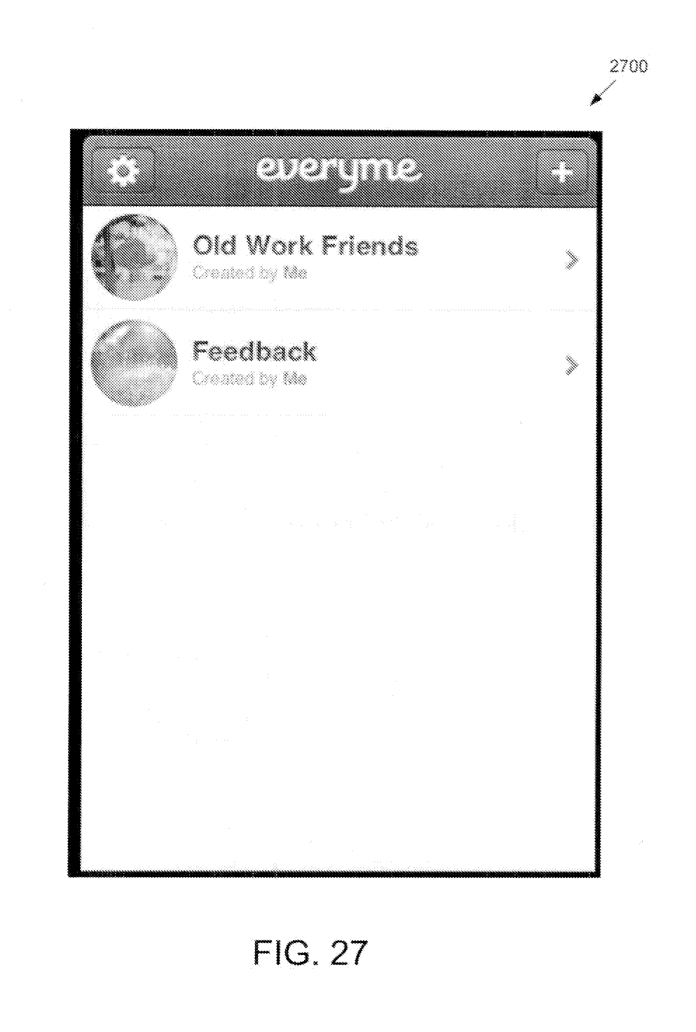

FIG. 26 shows an example of a screen 2600 depicting a settings to add contact information of a subscriber to a personal circle. In the example of FIG. 26, the screen 2600 can include an add phone number button, an add email button, and a cancel button. If the user selects the add phone number button, the privacy based social content service provider can prompt the user to enter the name and phone number of another person. The privacy based social content service provider can further send the other person an authorization SMS message. In some embodiments, the authorization SMS message to the other person is similar to the authorization SMS message sent to the user who created the circle (see above). Moreover, if the user selects the add email address button, the privacy based social content service provider can prompt the user to enter the name and email address of another person. The privacy based social content service provider can further send the other person an authorization email. In various embodiments, the authorization email to the other person is similar to the authorization email sent to the user who created the circle (see above). The privacy based social content service provider can direct the user to the screen 2700, shown in FIG. 27.

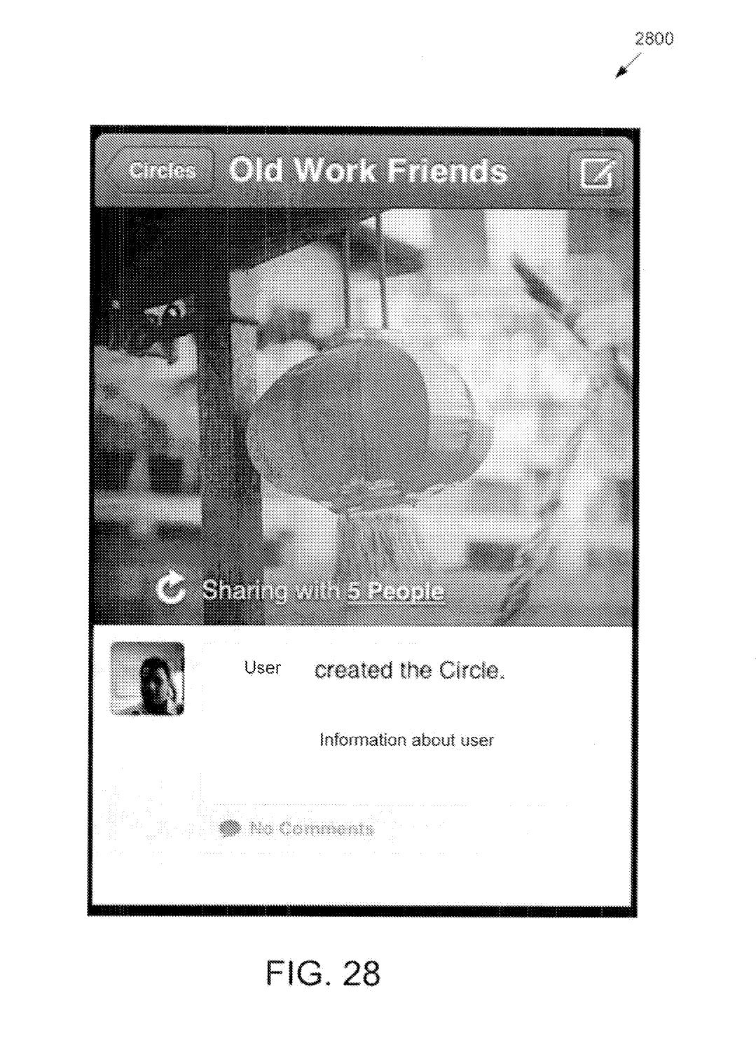

FIG. 27 shows an example of a screen 2700 depicting a list of circles that a user is a member of In the example of FIG. 27, the screen 2700 includes a title bar having a settings button, a title, and an add circle button. In this example, the screen 2700 includes an Old Work Friends button and a Feedback button. The Old Work Friends button links a user to the Old Work Friends circle and the Feedback button links the user to the Feedback circle. The user's Feedback circle was discussed earlier. In this example, if the user clicks the Old Work Friends button, the privacy based social content service provider can direct the user to the screen 2800, shown in FIG. 28.

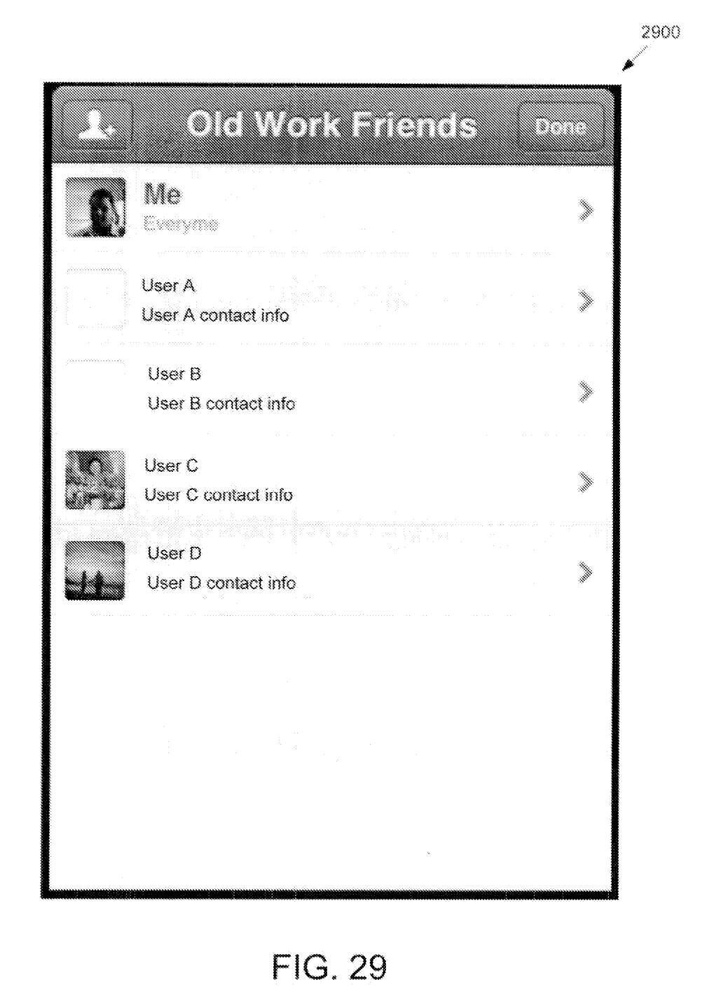

FIG. 28 shows an example of a screen 2800 depicting a home screen of a personal circle. In the example of FIG. 28, the screen 3100 can include a title bar containing a circles button, a title (here “Old Work Friends”), and a compose button. The screen 2800 can also contain a subscriber number (shown in FIG. 28 as “5 People”) corresponding to the number of people subscribing to the circle. In the example of FIG. 28, the screen 2800 can also include a user introduction feed that can present the user's background or other information to the circle. The screen 2800 can also facilitate entry of comments regarding the user introduction feed. In this example, the phrase “5 People” operates as a hyperlink to link the user with the specific subscribers in his or her circle. For instance, clicking the phrase “5 People” can direct a user to a subscriber list such as the subscriber list shown in FIGS. 14 and 29.

FIG. 29 shows an example of a screen 2900 depicting a subscriber list associated with a personal circle. In the example of FIG. 29, the screen 2900 can include a title bar having an add subscriber button, a title, and a done button. In the example of FIG. 29, the screen 2900 can include a set of subscribers, beginning with the user, labeled in this figure as “Me.” For each subscriber, the screen 2900 can display contact information, such as an email address or a mobile phone number. The contact information for a given subscriber could match the preferred contact information that the given subscriber has provided to the privacy based social content service provider when the given subscriber's contact information was initially verified. The contact information could also match the way that the user (i.e., the circle creator) indicated he or she preferred to contact a given subscriber. In various embodiments, the screen 2900 can present each subscriber as a button that can be clicked to modify either the subscriber's user name or contact information.

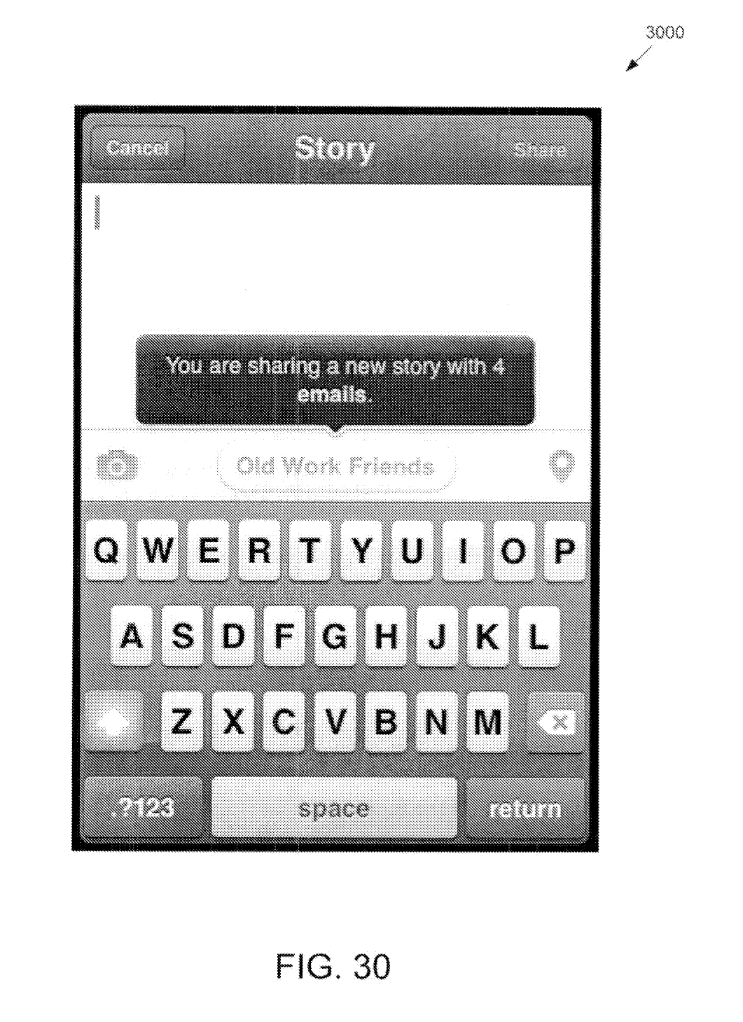

FIG. 30 shows an example of a screen 3000 depicting story creation associated with a personal circle. The screen 3000 can be accessed when a user clicks the compose button (such as the button shown in screen 2800 of FIG. 28). In the example of FIG. 30, the screen 3000 can have a title bar including a cancel button, a title (here “Story”), and a share button. The screen 3000 can also display a story field that permits a user to write and publish a story to a circle. In this example, the screen 3000 is to publish a story to a user's “Old Work Friends” circle. The story field can include a camera button that allows a user to upload an image from a file or an attached camera to the story. The story field can also include a locational button that allows the user to apply a locational tag to his or her story. In this example, the story field accepts textual input via a touchscreen but those of ordinary skill in the art will appreciate that other input methods are available. Further, in the example of FIG. 30, the screen 3000 can include a bubble indicating the number of subscribers that a story is being shared with (here 4 subscribers).

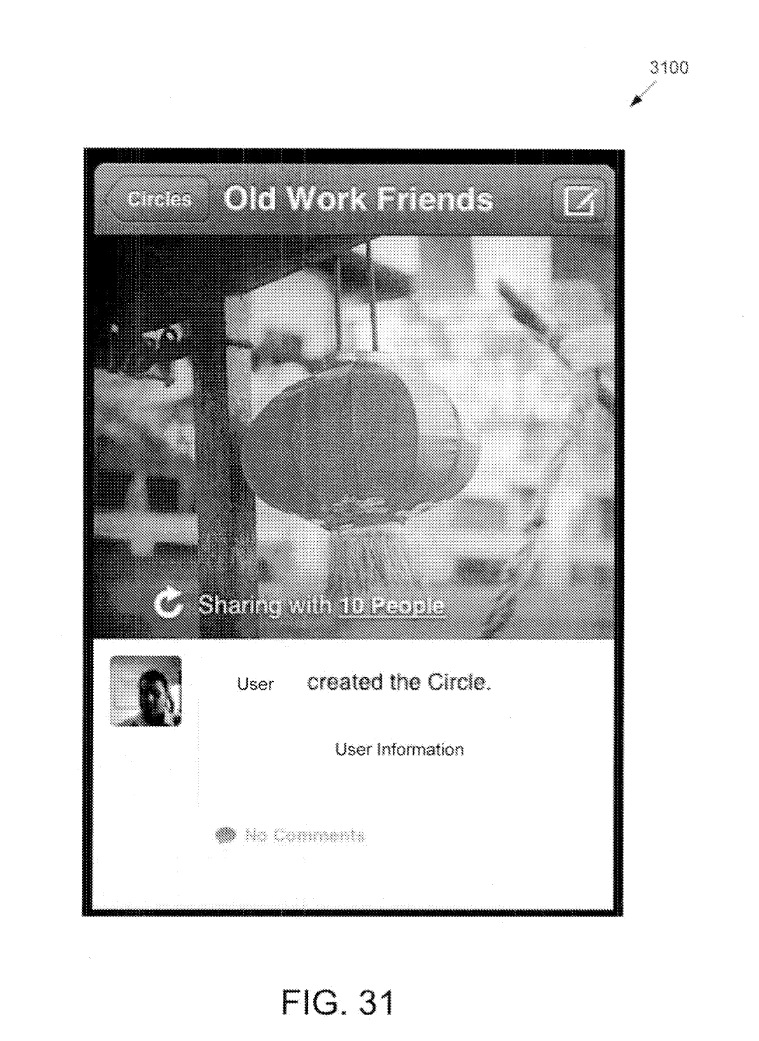

FIG. 31 shows an example of a screen 3100 depicting a home screen of a personal circle. In the example of FIG. 31, the screen 3100 can include a title bar containing a circles button, a title (here “Old Work Friends”), and a compose button. The screen 3100 can also contain a subscriber number (shown in FIG. 31 as “10 People”) corresponding to the number of people subscribing to the circle. In the example of FIG. 31, the screen 3100 can also include a user introduction feed that can present the user's background or other information to the circle. The screen 3100 can also facilitate entry of comments regarding the user introduction feed. In this example, the phrase “10 People” operates as a hyperlink to link the user with the specific subscribers in his or her circle. For instance, clicking the phrase “10 People” can direct a user to a subscriber list. (A subscriber list having 5 subscribers is shown in FIG. 29.)

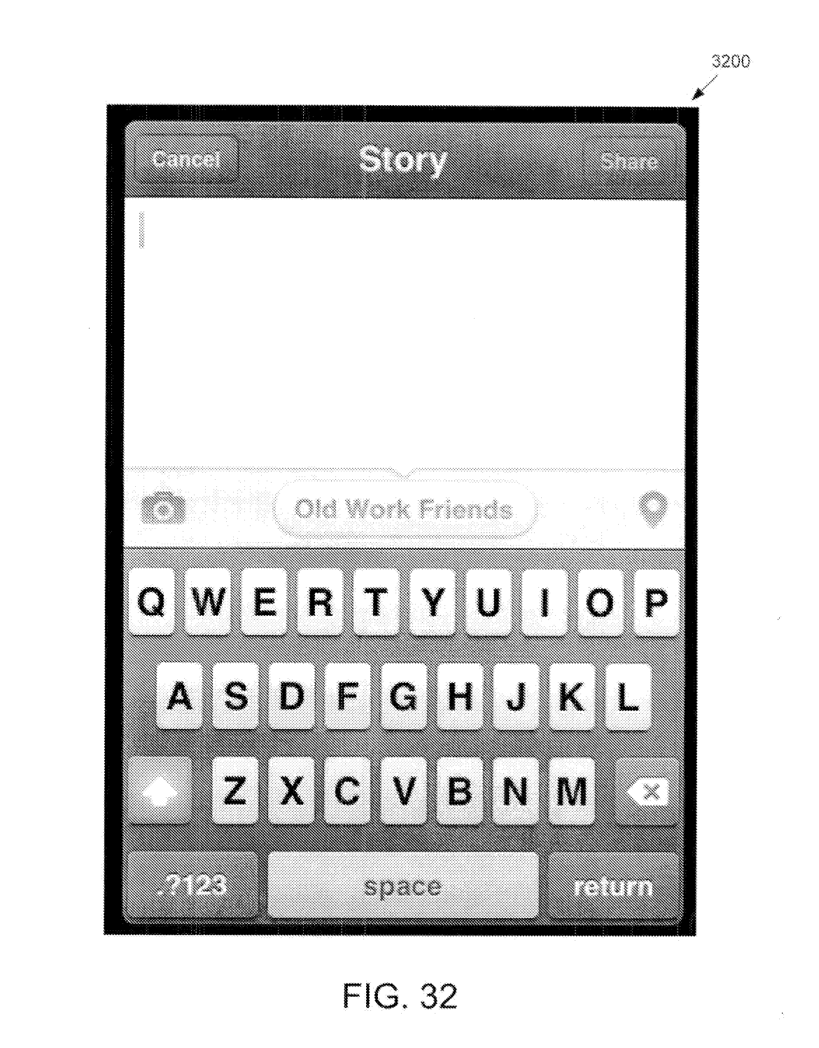

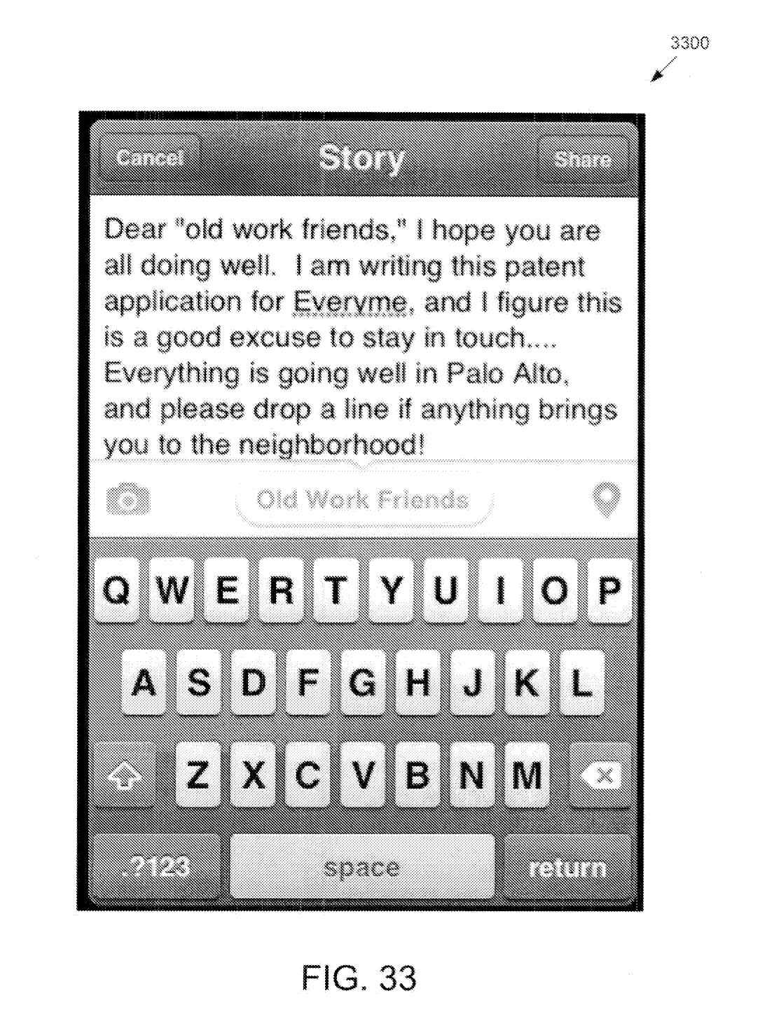

FIG. 32 shows an example of a screen 3200 depicting story creation associated with a personal circle. The screen 3200 can be accessed when a user clicks the compose button (such as the button shown in screen 3100 of FIG. 31). In the example of FIG. 32, the screen 3200 can have a title bar including a cancel button, a title (here “Story”), and a share button. The screen 3200 can also display a story field that permits a user to write and publish a story to a circle. In this example, the screen 3200 is to publish a story to a user's “Old Work Friends” circle. The story field can include a camera button that allows a user to upload an image from a file or an attached camera to the story. The story field can also include a locational button that allows the user to apply a locational tag to his or her story. In this example, the story field accepts textual input via a touchscreen but those of ordinary skill in the art will appreciate that other input methods are available. A user can write a story into the story field, as depicted in FIG. 33.

FIG. 33 shows an example of a screen 3300 depicting story creation associated with a personal circle. In the example of FIG. 33, the screen 3300 can include a title bar containing a cancel button, a title (here “Story”), and a share button. In the example of FIG. 33, a user has written a story to subscribers of the “Old Work Friends” circle. The story informs the subscribers of recent developments and invites the subscribers to keep in touch. A user can click the share button on the top right hand corner of the title bar to publish the story to the subscribers of the circle. In some embodiments, a privacy based social content service provider can present a user a request to turn on magic stories in response to the clicking of the share button on the screen 3300.

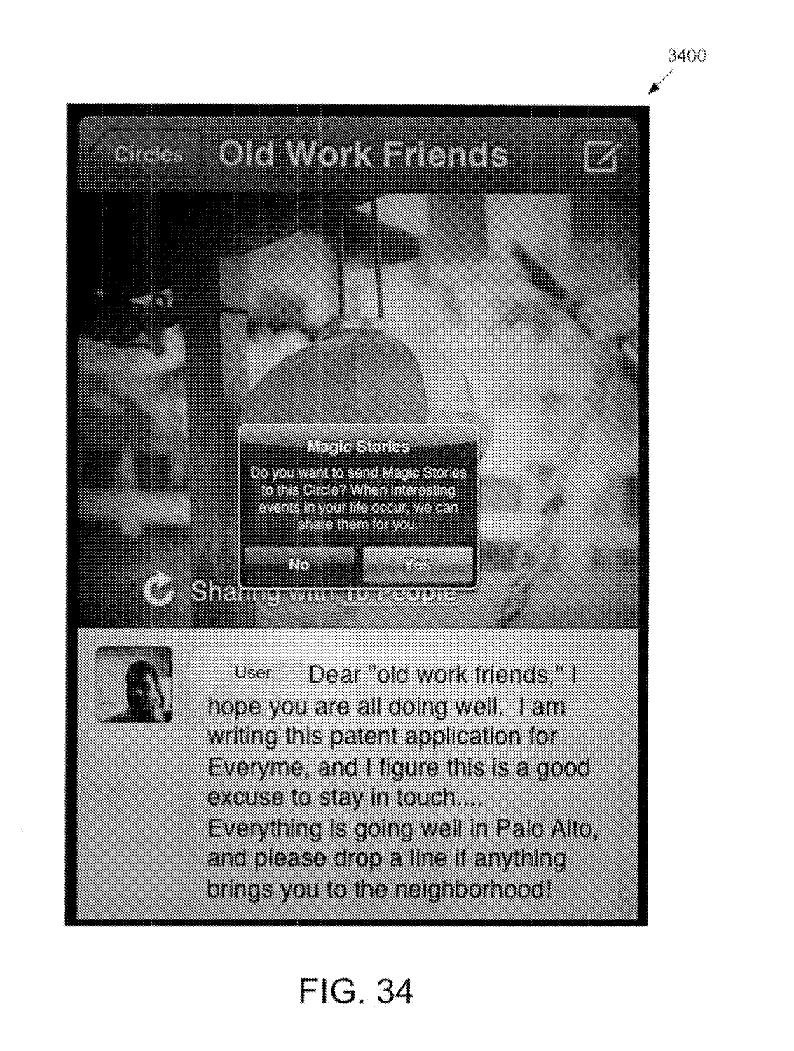

For example, the privacy based social content service provider can present the user with the screen shown in FIG. 34, which shows an example of a screen 3400 depicting a request to turn on magic circles. As used herein, magic stories are stories related to events of particular importance in the privacy based social content system. The magic stories can be shared with a circle's subscribers as the magic stories are posted. A user can turn on magic stories by clicking yes to a dialog box, such as the dialog box illustrated in FIG. 34. Whether or not the user decides to turn on magic stories, the user can be presented with a story creation screen.

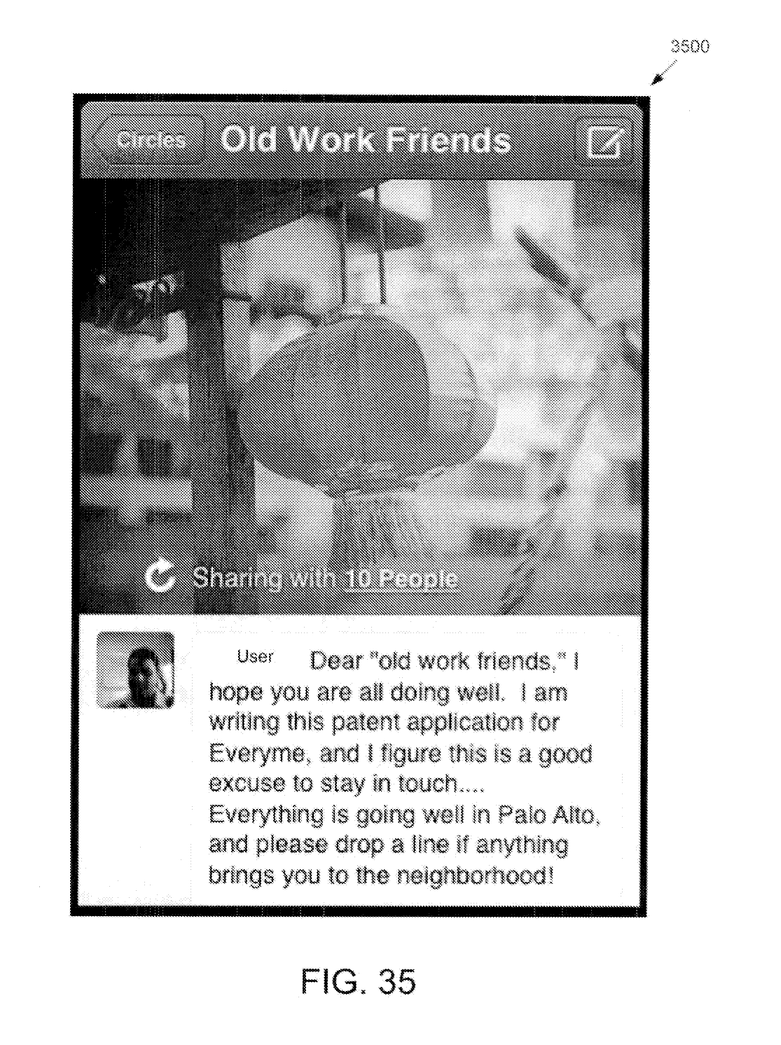

FIG. 35 shows an example of a screen 3500 depicting story creation associated with a personal circle. In the example of FIG. 35, the screen 3500 can include a title bar containing a circles button, a title (here “Old Work Friends”), and a compose button. The screen 3500 can be accessed when a user has clicked a share button, such as the share button in the screen 3300 of FIG. 33. In the example of FIG. 35, the story field has been filled in with the story entered into the screen 3300 of FIG. 33. The user has published the story, and correspondingly, the story is accessible to all subscribers of the Old Work Friends circle.

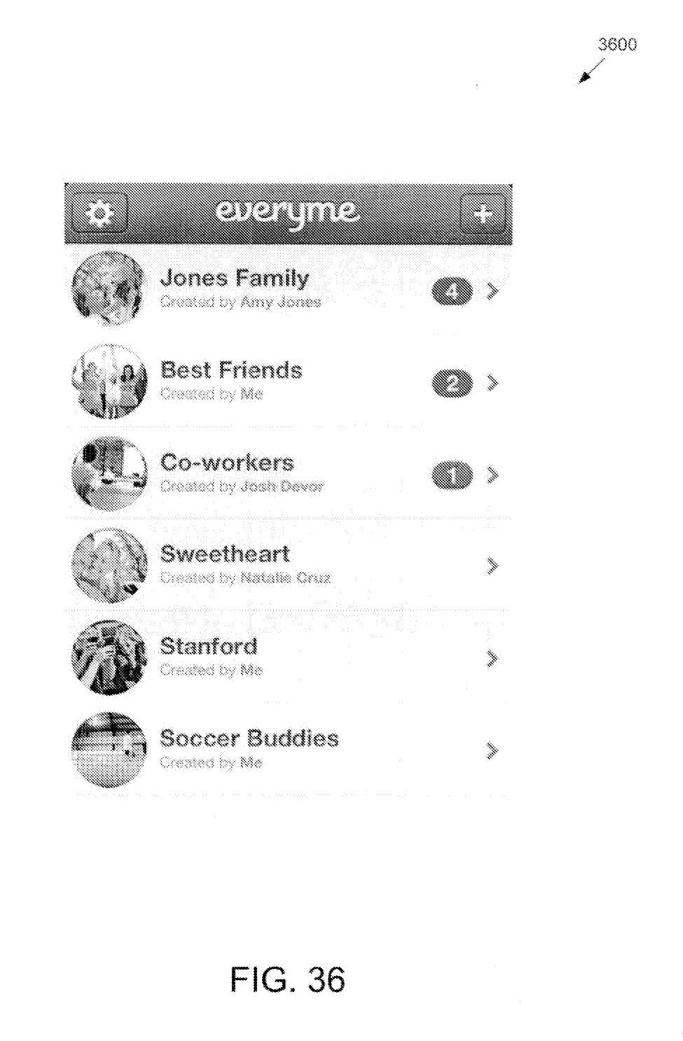

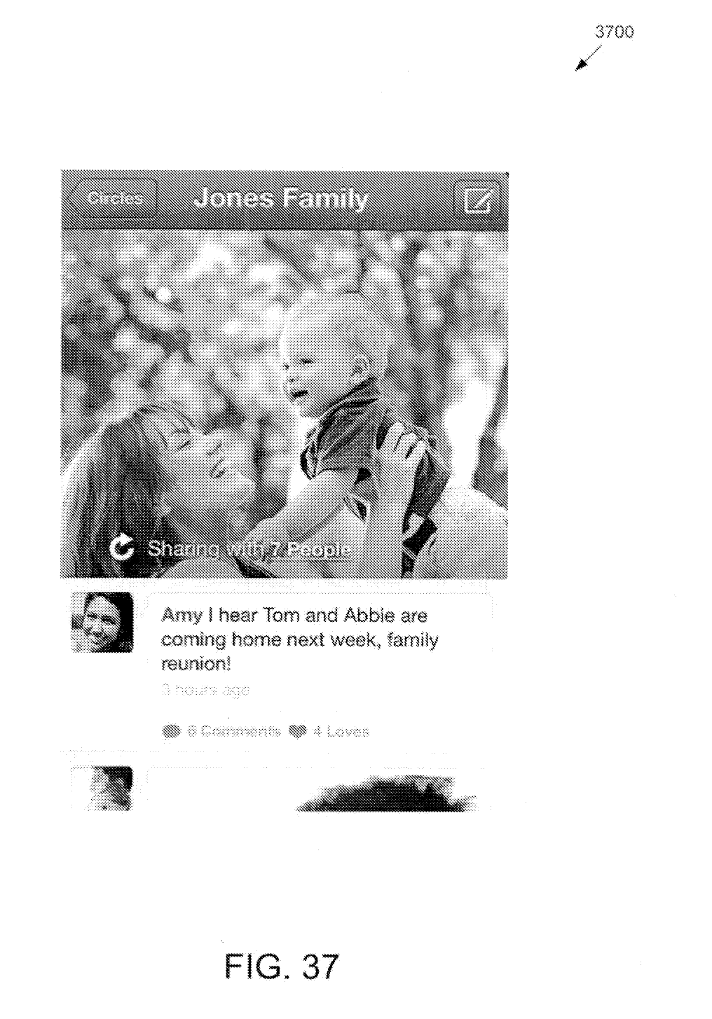

FIG. 36 shows an example of a screen 3600 depicting a list of circles of which a user is a member. In the example of FIG. 36, the screen 3600 includes a title bar having a settings button, a title, and an add circle button. In this example, the screen 3600 includes a Jones Family button, a Best Friends button, a Co-workers button, a Sweetheart button, a Stanford button, and a Soccer Buddies button. In this example, the Jones Family button corresponds to a Jones Family circle created by the user Amy Jones, the Best Friends button corresponds to a Best Friends circle created by the user viewing the application, the Co-workers button corresponds to a Co-workers circle created by the user Josh Devor, the Sweetheart button corresponds to a Sweetheart circle created by the user Natalie Cruz, the Stanford button corresponds to a Stanford circle created by the user viewing the application, and the Soccer Buddies button corresponds to a Soccer Buddies circle created by the user viewing the application. In this example, if the user clicks the Jones Family button, the privacy based social content service provider can direct the user to the screen 3700, shown in FIG. 37.

Old Work Friends button and a Feedback button. The Old Work Friends button links a user to the Old Work Friends circle and the Feedback button links the user to the Feedback circle. The user's Feedback circle was discussed earlier. In this example, if the user clicks the Old Work Friends button, the privacy based social content service provider can direct the user to the screen 2800, shown in FIG. 28.

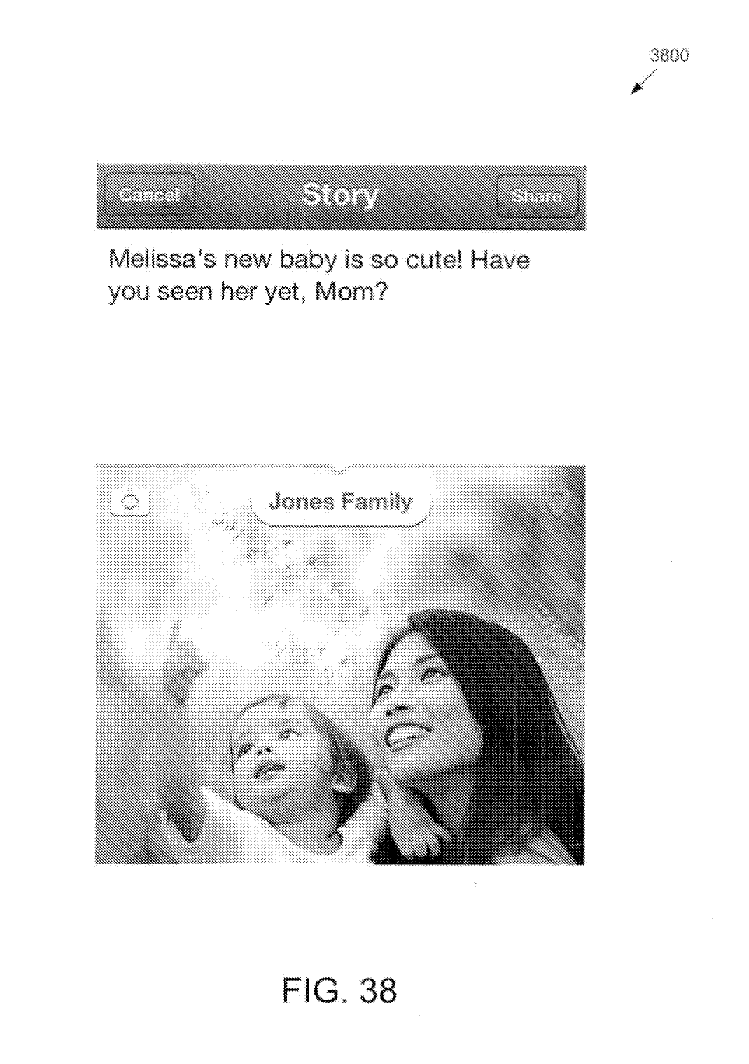

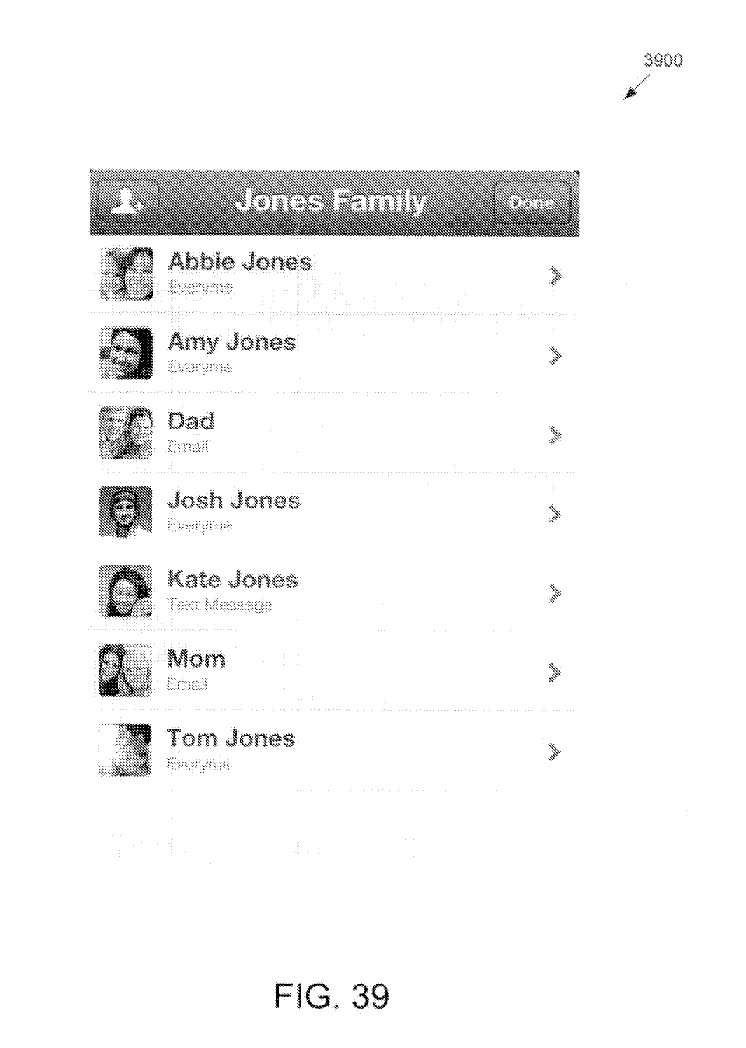

FIG. 37 shows an example of a screen 3700 depicting a home screen of a personal circle. In the example of FIG. 37, the screen 3700 can include a title bar containing a circles button, a title (here “Jones Family”), and a compose button. The screen 3700 can also contain a subscriber number (shown in FIG. 37 as “7 People”) corresponding to the number of people subscribing to the circle. In the example of FIG. 37, the screen 3700 can also include a user introduction feed that can present the user's background or other information to the circle. The screen 3700 can also show the entries to the circle from other subscribers. In this example, the phrase “7 People” operates as a hyperlink to link the user with the specific subscribers in his or her circle; the privacy based social content service provider can direct the user to the screen 3900 of FIG. 39 in response to clicking the hyperlink. Further, in this example, the user Amy Jones has shared that she has heard that Tom and Abbie are returning to town and it may be time for a family reunion. The post from Amy Jones has six comments and four loves. It is noted that Amy Jones may have submitted her post via text message, email, or through the application of the privacy based social content service provider. In this example, if a user clicks the compose button at the top right hand corner, the privacy based social content service provider can direct the user to the screen 3800, shown in FIG. 38.

FIG. 38 shows an example of a screen 3800 depicting story creation associated with a personal circle. Screen 3800 can be accessed when a user clicks the compose button (such as the button shown in screen 3700 of FIG. 37). In the example of FIG. 38, the screen 3800 can have a title bar including a cancel button, a title (here “Story”), and a share button. The screen 3800 can also display a story field that permits a user to write and publish a story to a circle. In this example, the screen 3800 is to publish a story to a user's “Jones Family” circle. The story field can include a camera button that allows a user to upload an image from a file or an attached camera to the story. The story field can also include a locational button that allows the user to apply a locational tag to his or her story. In this example, the story field accepts textual input via a touchscreen but those of ordinary skill in the art will appreciate that other input methods are available.

FIG. 39 shows an example of a screen 3900 depicting a subscriber list associated with a personal circle. In the example of FIG. 39, the screen 3900 can include a title bar having an add subscriber button, a title, and a done button. In the example of FIG. 39, the screen 3900 can include a set of subscribers, beginning with the user “Abbie Jones.” For each subscriber, the screen 3900 can display contact information, such as an email address, a mobile phone number, or the privacy based social content service provider (e.g., “Everyme”). The contact information for a given subscriber could match the preferred contact information that the given subscriber has provided to the privacy based social content service provider when the given subscriber's contact information was initially verified. The contact information could also match the way that the user (i.e., the circle creator) indicated he or she preferred to contact a given subscriber. In various embodiments, the screen 3900 can present each subscriber as a button that can be clicked to modify either the subscriber's user name or contact information.

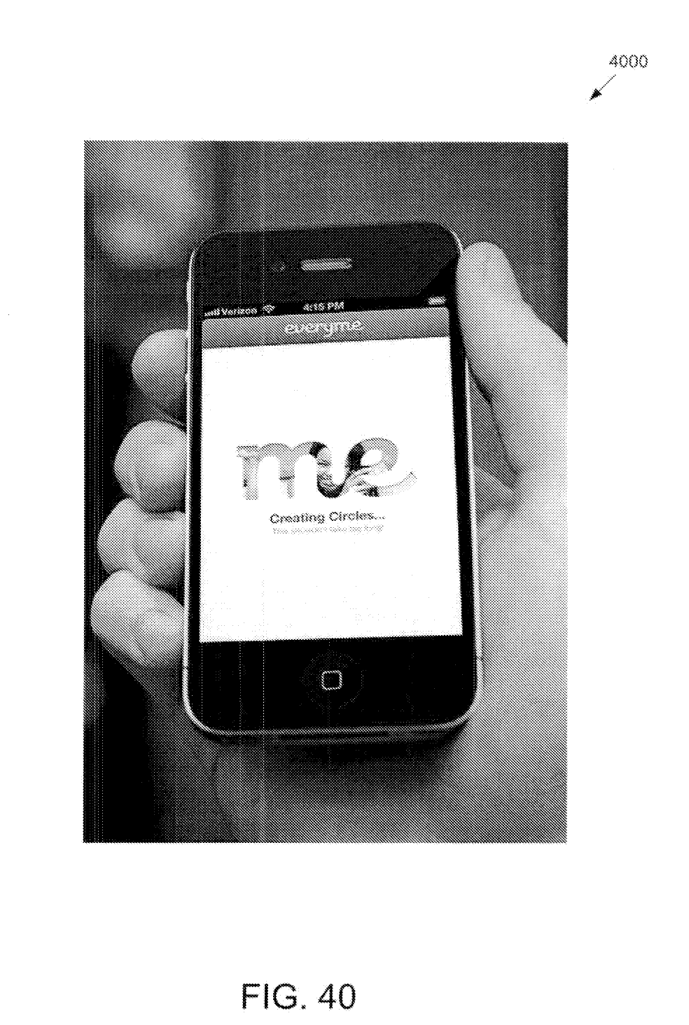

FIG. 40 shows an example of a screen 4000 of a mobile phone application. In the example of FIG. 40, the screen 4000 is a screen for an iPhone™ made by Apple™.

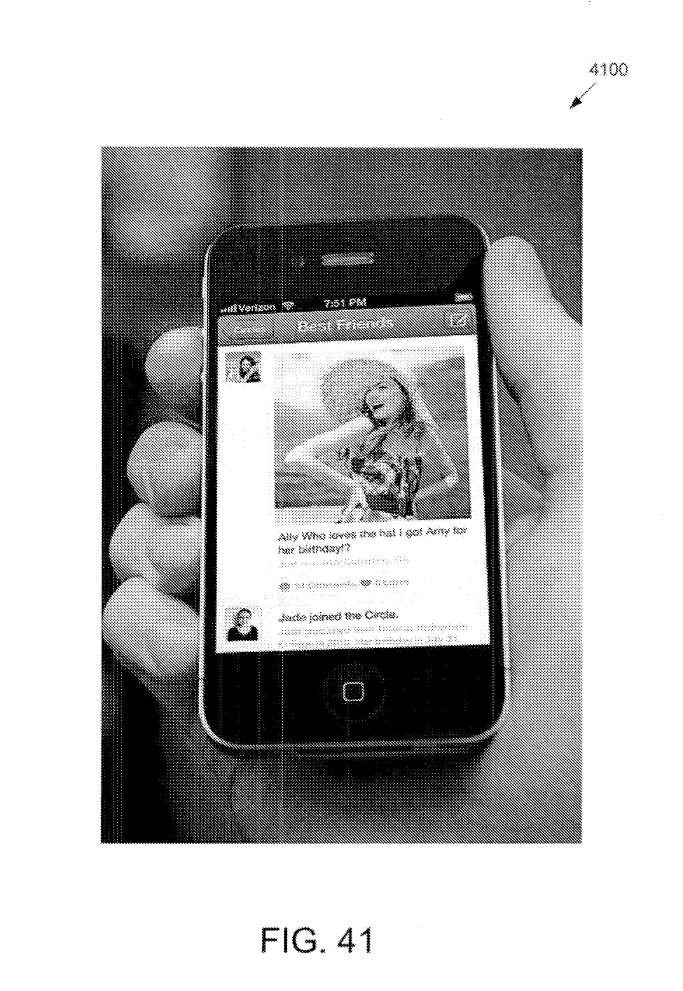

FIG. 41 shows an example of a screen 4100 of a mobile phone application. In the example of FIG. 41, the screen 4100 is a screen for an iPhone™ made by Apple™.

Although the foregoing embodiments have been described in some detail for purposes of clarity of understanding, the invention is not necessarily limited to the details provided.

What is claimed:

1. A method comprising:
authenticating a user;
creating a circle between the user and a subscriber through a privacy based social content broadcast service system;
receiving first content from the user;
sending the first content through the circle to the subscriber.

2. The method of claim 1, further comprising:
receiving second content from the subscriber;
sending the second content through the circle to the user.

3. The method of claim 1, further comprising, authenticating the subscriber.

4. The method of claim 1, wherein the first content is sent to the subscriber as a short message service (SMS) message.

5. The method of claim 2, wherein the second content is a response of the subscriber to the first content.

6. The method of claim 1, wherein the user and the subscriber are associated other than being in the circle together.

7. The method of claim 1, further comprising:
generating a third content related to the user from a network that the user is associated with;
sending the third content through the circle to the subscriber.

8. The method of claim 1, wherein the circle is created between the user and the subscriber based on information about the subscriber received from the user.

9. The method of claim 1, wherein the circle is created between the user and the subscriber based on information about the subscriber retrieved from a network of which the user and the subscriber are both associated.

10. The method of claim 2, further comprising:
receiving content preferences of the user;
sending the second content through the circle to the user only if the second content meets the content preferences of the user.

11. A system comprising:
a privacy based social content broadcast service system configured to:
authenticate a user;
create a circle between the user and a subscriber;
receive first content from the user;
a communication interface system configured to send the first content through the circle to the subscriber.

12. The system of claim 11, wherein:
the privacy based social content service system is further configured to receive second content from the subscriber;
the communication interface system is further configured to send the second content through the circle to the user.

13. The system of claim 11, wherein the privacy based social content broadcast service system is further configured to authenticate the subscriber.

14. The system of claim 11, wherein the communication interface system is further configured to send the first content to the subscriber as a short message service (SMS) message.

15. The system of claim 12, wherein the second content is a response of the subscriber to the first content.

16. The method of claim 11, wherein the user and the subscriber are associated other than being in the circle together.

17. The system of claim 11, wherein:
the privacy based social content broadcast service system is further configured to generate a third content related to the user from a network that the user is associated with;
the communication interface system is further configured to send the third content through the circle to the subscriber.

18. The system of claim 11, wherein the circle is created between the user and the subscriber based on information about the subscriber received from the user.

19. The system of claim 11, wherein the circle is created between the user and the subscriber based on information about the subscriber retrieved from a network of which the user and the subscriber are both associated.

20. The system of claim 12, wherein:
the privacy based social content broadcast service system is further configured to receive content preferences of the user;
the communication interface system is further configured to send the second content through the circle to the user only if the second content meets the content preferences of the user.

21. A system comprising:
means for authenticating a user;
means for creating a circle between the user and a subscriber;
means for receiving first content from the user;
means for sending the first content through the circle to the subscriber.
